(19) United States
(12) Patent Application Publication
(10) Pub. No.: US 2004/0037188 A1
(43) Pub. Date: Feb. 26, 2004

(54) Optical disk apparatus capable of adjusting phase of reproduction clock and phase adjustment method

(75) Inventors: Kenji Asano, Osaka (JP); Takako Araki, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Sanyo Electric Co. LTD, Moriguchi-shi Osaka (JP)

(21) Appl. No.: 10/399,773

(22) PCT Filed: Oct. 18, 2001
(86) PCT No.: PCT/JP01/09163

(30) Foreign Application Priority Data
Oct. 26, 2000 (JP) 2000-327143

(51) Int. Cl. G11B 7/00

(52) U.S. Cl. 369/47.35; 369/59.21

(57) ABSTRACT

A phase adjusting circuit (128) detects an amount of phase shift of a reproduction signal RFn sampled in synchronization with clock CLKn−1 from a waveform equalizing circuit (108), and corrects clock CLKn−1 in accordance with the amount of phase shift to produce a corrected clock RCLKn. A clock setting circuit (127) arithmetically determines a moving average of the clock CLKn−1 and the corrected clock RCLKn to produce a clock CLKn used for sampling reproduction signal RFn. The clock setting circuit (127) arithmetically determines the average of n phases of n clocks CLKn, and sets the clock having the average phase as the reproduction clock. Consequently, it is possible to produce the clock allowing accurate sampling of the reproduction signal reproduced from the optical disk.

### TECHNICAL FIELD

The present invention relates to an optical disk device, which adjusts a phase of a reproduction clock when it reproduces signals from an optical disk, and a phase adjusting method.

### BACKGROUND ART

In optical disks such as a magneto-optical disk and a phase change disk, lands and grooves are formed alternately in a radial direction, and signals are recorded on both the lands and the grooves for achieving a high density.

According to AS-MO (Advanced Storaged Magneto Optical disk) standards, which are recently established, fine clock marks forming a reference for producing a clock, which is used for recording or reproducing data, are formed at predetermined intervals. More specifically, the fine clock marks are formed in such a manner that grooves each having a length of about 3 to 4 data channel bits are formed at predetermined intervals on the land, and lands each having a length of about 3 to 4 data channel bits are formed at predetermined intervals in the groove. For avoiding an influence on reproduced data by the fine clock marks, data is not recorded in regions, which are located on upstream and downstream sides of a fine clock mark and each has a length of 6 data channel bits (i.e., 12 data channel bits in total).

In the magneto-optical disk according to the AS-MO standards, recording and reproducing of signals are performed in synchronization with a clock, which is produced by detecting fine clock marks. For producing signals, it is preferable to perform sampling in accordance with timing, which provides a maximum amplitude of a magneto-optical signal detected with a laser beam from the magneto-optical disk. Therefore, the phase of the clock is adjusted to match with the timing providing the maximum amplitude of the magneto-optical signal.

More specifically, a record signal of “110011001100 . . . formed of signals of 2T arranged at intervals of 2T is recorded on a magneto-optical disk, and the signal thus recorded is reproduced. Thereby, the amplitude of the magneto-optical signal changes sinusoidally. Therefore, the phase of the clock is adjusted to match with peaks of a sinusoidal wave.

However, when changes occur in an ambient temperature of the magneto-optical disk, an intensity of the laser beam or the like, these changes cause a shift or deviation of a center of a domain formed on the magneto-optical disk, resulting in a shift or deviation of timing for sampling the magneto-optical signal detected with the laser beam. Referring to FIGS. 23A and 23B, when laser beams have a large power, laser beams LB1 and LB2 each having a large beam diameter, within which a magnetic layer of the magneto-optical disk is heated to or above a predetermined temperature, are emitted onto the magneto-optical disk. When a temperature of a region irradiated with laser beam LB1 rises to or above the Curie temperature, and then lowers below the Curie temperature, this region in the magnetic layer of the magneto-optical disk is magnetized by an external magnetic field modulated with a record signal in the same direction as that of the external magnetization. In accordance with next timing, laser beam LB2 is irradiated to heat the magnetic layer to or above the Curie temperature so that a domain D1 is formed (see FIG. 23A).

If the power of laser beams is low although the irradiation is performed in accordance with the same timing, laser beams LB3 and LB4 each having a small beam diameter, within which the magnetic layer of the magneto-optical disk is heated to or above the predetermined temperature, are emitted onto the magneto-optical disk. Thereby, a domain D2 is formed in the same manner as that described above (see FIG. 23B).

In the above case, a center CA of domain D1 is shifted from a center CB of domain D2 by a distance L in a tangential direction of the magneto-optical disk. This results in the following problem. If the clock produced based on the fine clock mark has a uniform phase, the timing of sampling of the magneto-optical signal reproduced from domain D1 matches with the phase of the clock, but the timing of sampling of the magneto-optical signal reproduced from domain D2 does not match with the phase of the clock. Consequently, the signal cannot be produced accurately.

If the signal is recorded at a higher density on the magneto-optical disk, the sizes of domains formed on the lands or grooves further decrease so that the magneto-optical signal reproduced from the small domains has a small amplitude, and fluctuates to a large extent as shown in FIG. 24. This magneto-optical signal causes such a problem that the sampling timing is liable to deviate from the timing of occurrence of a large amplitude.

The above problems may occur not only in the magneto-optical disk but also in an optical disk, in which a record position of a record signal changes depending on a power of a laser beam.

### DISCLOSURE OF THE INVENTION

Accordingly, an object of the invention is to provide an optical disk device, which can produce a clock allowing accurate sampling of a reproduction signal reproduced from an optical disk, and a phase adjusting method.

The invention provides an optical disk device reproducing a signal from an optical disk including a fine clock mark providing a reference for producing a reference clock, including an optical pickup emitting a laser beam onto the optical disk and detecting a reflected beam; a clock producing circuit producing the reference clock based on a fine clock mark signal detected based on the fine clock mark by the optical pickup; a sampling circuit sampling a reproduction signal RFn (n: natural number) reproduced from the optical disk by the optical pickup in synchronization with the reference clock when n is equal to one, and sampling the reproduction signal RFn in synchronization with a clock CLKn−1 suitable to sampling of a reproduction signal RFn−1 immediately preceding the reproduction signal RFn when n is larger than one; a phase adjusting circuit determining a correction amount required for correction of a phase of the clock CLKn−1 by comparing a sample value of the reproduction signal RFn with a reference value, and producing a corrected clock RCLKn having a phase suitable to the sampling of the reproduction signal RFn based on the correction amount; a clock setting circuit producing a clock CLKn by arithmetically obtaining a moving average of the clock CLKn−1 and the correction clock RCLKn, arithmetically obtaining an average value of n phases corresponding to the respective clocks CLKn of n in number, and setting the clock having the arithmetically obtained average phase as a reproduction clock; and a reproduction processing circuit performing reproduction processing on the reproduction signal reproduced by the optical pickup in synchronization with the reproduction clock.

According to the optical disk device of the invention, the reproduction signal reproduced from the optical disk by the optical pickup is sampled in synchronization with the clock suitable to the sampling of the last reproduction signal, and the sample value obtained by this sampling is compared with the reference value. Thereby, the correction amount, by which the phase of the clock used for the sampling is to be corrected, is determined. Based on the correction amount thus determined, the corrected clock suitable to the sampling of the reproduction signal is produced. The moving average of the corrected clock thus produced and the clock used for the sampling of the reproduction signal is arithmetically obtained to provide the clock suitable to the sampling of the reproduction signal of the signal to be reproduced. The above correction is effected on the clocks of n in number, and an average value is obtained from the respective phases thus corrected. The clock having the average phase is set as the reproduction clock, and the processing of the reproduction signal is performed in synchronization with the reproduction clock.

According to the invention, therefore, even when a shift occurs in position of the signal recorded on the optical disk, the reproduction signal can be sampled in accordance with the timing providing a large amplitude of the reproduction signal.

Preferably, the reproduction signal RFn used for the phase adjustment of the clock is a reproduction signal reproduced by the optical pickup based on the recording signal recorded on the optical disk and having a uniform signal length.

In the optical disk device, the optical pickup reproduces the signal having the uniform signal length, and the phase of the clock is adjusted to suit to sampling of the reproduction signal. Thus, deviation of the position of the signal recorded on the optical disk causes shifting of the timing of sampling of the reproduction signal, and the phase of the clock is adjusted to allow sampling in accordance with the timing, which removes an influence by the positional deviation of the recording signal and provides a large amplitude of the reproduction signal.

Therefore, the invention can easily remove deterioration of characteristics of the reproduction signal, which may be caused by the positional deviation of the signal recorded on the optical disk.

Preferably, the reproduction signal RFn used for the phase adjustment of the clock is the reproduction signal reproduced by the optical pickup based on the recording signal recorded at a leading position of a user data region on the optical disk.

The optical disk device adjusts the clock phase to suit to the sampling of the reproduction signal before starting an operation of reproducing the recording signal recorded in the user data region.

According to the invention, therefore, the recording signal recorded in the user data region can be accurately reproduced.

Preferably, the optical disk includes a land, a groove neighboring to the land and a magnetic layer covering surfaces of the land and the groove, the groove and the land include the fine clock marks at predetermined intervals in the tangential direction, a data format of the optical disk is formed of a plurality of frames and a plurality of segments forming each of the plurality of frames, a region between the neighboring two fine clock marks is assigned to each of the plurality of segments, and the optical pickup provides the reproduction signal RFn by detecting the recording signal recorded in one of the plurality of segments.

The optical disk device reproduces the recording signal recorded in one of the plurality of segments forming one of the frames, and adjusts the clock phase to suit to the sampling of the reproduction signal.

According to the invention, therefore, the adjustment of the clock phase can be performed by using the recording signal of the same unit as the recording signal recorded in one segment. Consequently, the original recording signal can be accurately reproduced even when a deviation occurs in the recording position of the original recording signal.

Preferably, the optical pickup of the optical disk device provides the reproduction signal RFn by detecting the recording signal recorded in one of the plurality of segments forming each of the plurality of frames.

The optical disk device reproduces the recording signal recorded in each of the plurality of frames, and adjusts the clock phase to suit to the sampling of the reproduction signal.

According to the invention, therefore, the recording signal can be accurately reproduced throughout the optical disk.

Preferably, a first recording signal having a first signal length and a second recording signal having a second signal length longer than the first signal length are recorded in the one segment, and the optical pickup reproduces the first recording signal to provide the reproduction signal RFn.

Between the two signals recorded on the one segment and having different signal lengths, the signal having a shorter signal length is reproduced to perform the phase adjustment of the clock.

According to the invention, therefore, the phase adjustment of the clock can be performed based on the recording signal, of which recording position is liable to deviate.

The invention also provides a phase adjusting method of adjusting a phase of a reproduction signal when reproducing a signal from an optical disk including a fine clock mark providing a reference for producing a reference clock, including a first step of reproducing a signal from the optical disk by emitting a laser beam onto the optical disk; a second step of sampling a reproduction signal RFn (n: natural number) reproduced in the first step in synchronization with the reference clock when n is equal to one, and sampling the reproduction signal RFn in synchronization with a clock CLKn−1 suitable to sampling of a reproduction signal RFn−1 immediately preceding the reproduction signal RFn when n is larger than one; a third step of determining a correction amount required for correction of a phase of the clock CLKn−1 by comparing a sample value of the reproduction signal RFn sampled in the second step with a reference value, and producing a corrected clock RCLKn having a phase suitable to the sampling of the reproduction signal RFn based on the correction amount; and a fourth step of producing a clock CLKn by arithmetically obtaining a moving average of the clock CLKn−1 and the correction clock RCLKn, arithmetically obtaining an average value of n phases respectively corresponding to the clocks CLKn of n in number, and setting the clock having the arithmetically obtained average phase as a reproduction clock.

According to the phase adjusting method of the invention, the reproduction signal reproduced from an optical disk is sampled in synchronization with the clock suitable to the sampling of the last reproduction signal, and a sample value obtained by this sampling is compared with the reference value to determine the correction amount, by which the phase of the clock used for the sampling is to be corrected. Based on the correction amount thus determined, the corrected clock suitable to the sampling of the reproduction signal is produced. The moving average of the corrected clock thus produced and the clock used for the sampling of the reproduction signal is arithmetically obtained to provide the clock suitable to the sampling of the reproduction signal of the signal to be reproduced. The above correction is effected on the clocks of n in number, and an average value is obtained from the respective phases thus corrected. The clock having the average phase is set as the reproduction clock.

According to the invention, therefore, even when a shift occurs in position of the signal recorded on the optical disk, the reproduction signal can be sampled in accordance with the timing providing a large amplitude of the reproduction signal.

Preferably, the reproduction signal RFn is a reproduction signal based on the recording signal recorded on the optical disk and having a uniform signal length.

The signal having the uniform signal length is reproduced, and the phase of the clock is adjusted to suit to sampling of the reproduction signal thus reproduced. Thus, a deviation of the position of the signal recorded on the optical disk causes shifting of the timing for sampling the reproduction signal, and the phase of the clock is adjusted to allow sampling in accordance with the timing, which removes an influence by the positional deviation of the recording signal and provides a large amplitude of the reproduction signal.

Therefore, the invention can easily remove deterioration of characteristics of the reproduction signal, which may be caused by the positional deviation of the signal recorded on the optical disk.

### BRIEF DESCRIPTION OF THE DRAWINGS

FIG. 1 is a plan illustrating a magneto-optical recording medium and a format thereof.

FIG. 2 schematically shows a format of recording data rows.

FIG. 3 is a block diagram of an optical disk device.

FIG. 4 illustrates reproduction of data from a preformat region and a user data region.

FIG. 5 is a block diagram of a PLL circuit.

FIG. 6 illustrates production of a fine clock mark detection signal and a clock.

FIG. 7 illustrates detection of address information and production of an address detection signal.

FIG. 8 illustrates production of a timing signal.

FIG. 9 illustrates recording data rows recorded by an optical disk device on a magneto-optical recording medium.

FIG. 10 is a schematic block diagram of a format circuit in an embodiment of the invention.

FIG. 11 is a timing chart of signals for illustrating operations of a 532 count-up counter and a 39 count-up counter in a timing generating circuit illustrated in FIG. 11.

FIG. 12 is a chart of timing signals produced by the timing generating circuit illustrated in FIG. 10.

FIG. 13 is a waveform diagram of reproduction signals of 2T reproduced from a header shown in FIG. 2.

FIG. 14 is a waveform diagram illustrating a principle of detection of a phase deviation, and particularly illustrating a state where the phase of the reproduction signal is synchronized with a phase of a clock.

FIG. 15 is a waveform diagram illustrating the principle of detection of the phase deviation, and particularly illustrating a state where the phase of the reproduction signal leads the phase of the clock.

FIG. 16 is a waveform diagram illustrating the principle of detection of the phase deviation, and particularly illustrating a state where the phase of the reproduction signal lags behind the phase of the clock.

FIG. 17 illustrates a manner of producing the reproduction clock.

FIG. 18 is a block diagram of a phase adjusting circuit of the optical disk device shown in FIG. 3.

FIG. 19 is a circuit diagram of a correction amount detecting circuit shown in FIG. 18.

FIG. 20 is a timing chart of signals in the correction amount detecting circuit shown in FIG. 18.

FIG. 21 is a circuit diagram of a phase correcting circuit shown in FIG. 18.

FIG. 22 is a flowchart of a phase adjusting method according to the invention.

FIGS. 23A and 23B illustrate the fact that a position of a domain varies depending on a power of a laser beam.

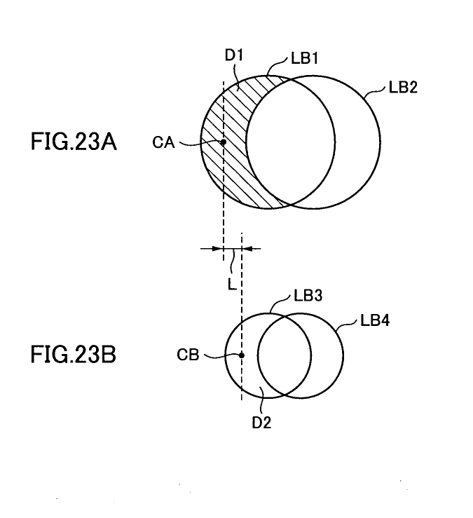

FIG. 24 is a waveform diagram of a signal reproduced from a magneto-optical recording medium provided with small domains.

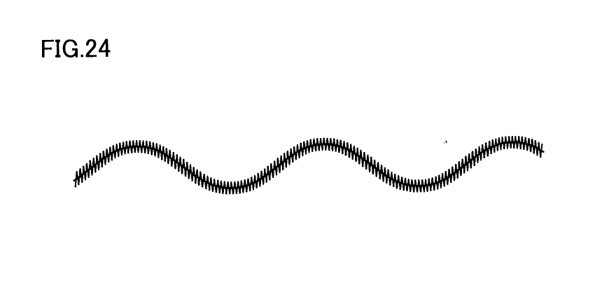

### BEST MODE FOR CARRYING OUT THE INVENTION

An embodiment of the invention will now be described with reference to the drawings. In the drawings, the same or corresponding portions bear the same reference numbers, and description thereof is not repeated.

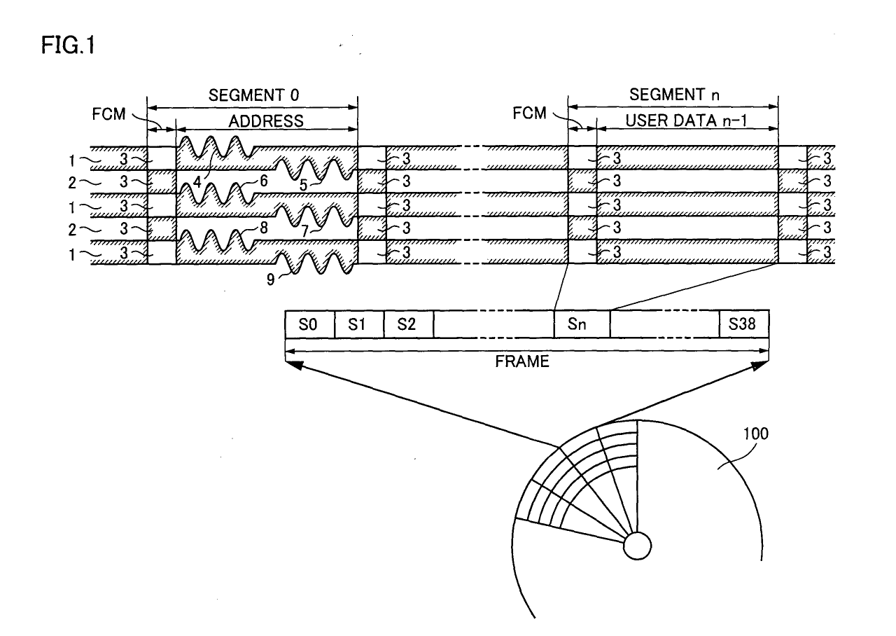

Referring to FIG. 1, description will now be given on a magneto-optical recording medium, on and/or from which data is recorded and/or reproduced by an optical disk device according to the invention. A magneto-optical recording medium 100 is provided with frames, which have angularly equal sizes and form record units, respectively. Each frame is formed of 39 segments S0, S1, S2, . . . and S38.

Magneto-optical recording medium 100 has a planar structure, in which grooves 1 and lands 2 are arranged alternately in the radial direction. Grooves 1 and lands 2 extend spirally or concentrically. Each segment has a length of 532 DCBs (Data Channel Bits), and is provided at its start position with a Fine Clock Mark (FCM) 3 representing phase information of a clock for recording and reproducing data. Fine clock marks 3 are formed by arranging lands of equal lengths at equal intervals in groove 1, and by arranging grooves of equal lengths at equal intervals in land. Segment S0 in a start position of each frame is provided at a position following fine clock mark 3 with address information, which represents an address on magneto-optical recording medium 100, and is defined by wobbles 4-9. The address information is preformatted during manufacturing of the magneto-optical recording medium 100. Magneto-optical recording medium 100 is provided with a magnetic layer covering preformatted grooves 1, lands 2, fine clock marks 3 and wobbles 4-9. A laser beam is emitted to the magnetic layer, and a magnetic field modulated by a recording signal is applied so that the signal is recorded on magneto-optical recording medium 100. Also, a laser beam of a predetermined intensity is emitted to the magnetic layer, and a reflected beam thereof is detected so that the signal is reproduced from magneto-optical recording medium 100.

Wobbles 4 and 5 are formed on the opposite walls of the same groove 1, and bear the same address information. Likewise, wobbles 6 and 7 as well as wobbles 8 and 9 are formed on the opposite walls of the same grooves 1 for storing the same address information, respectively. The above manner of recording the address information is referred to as “single-sided stagger type”. By the single-sided stagger type, the address information can be detected accurately even when the laser beam shifts from the center of groove 1 or land 2 due to a tilt or the like of magneto-optical recording medium 100.

A region bearing the address information and a region bearing fine clock mark 3 are not utilized for recording user data. Segment Sn is formed of fine clock mark 3 and user data n−1

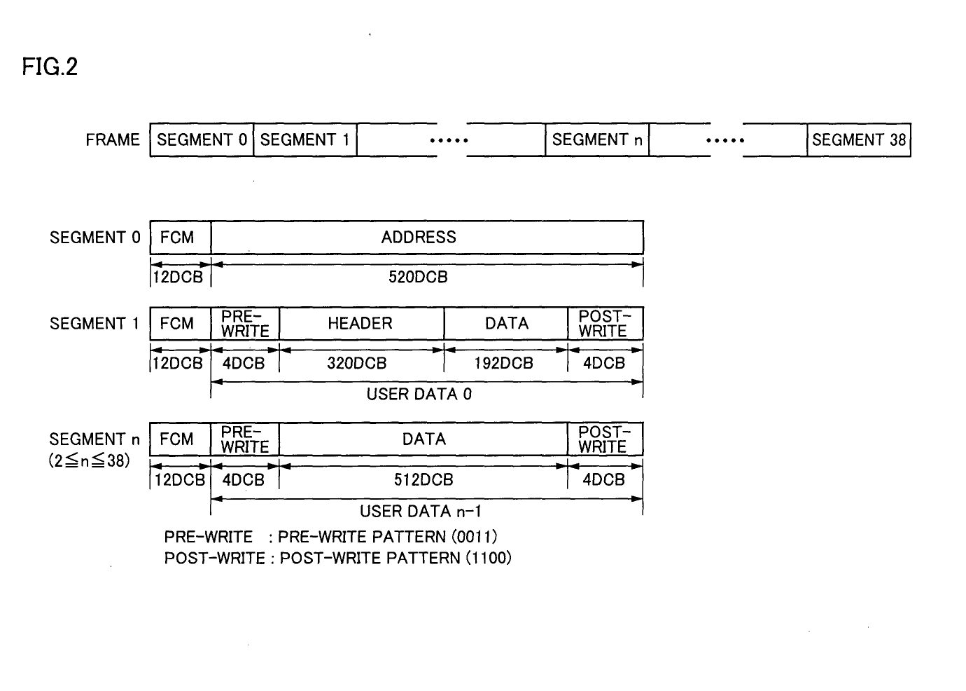

Referring to FIG. 2, specific structures of segments will now be described. Among segments S0, S1, S2, . . . S38 forming the frame, segment S0 is an address segment preformatted on magneto-optical recording medium 100. Segments S1-S38 are data segments provided as regions for recording the user data. Segment S0 is formed of a fine clock mark region FCM of 12 DCBs and an address of 520 DCBs. Segment S1 is formed of fine clock mark region FCM of 12 DCBs, a pre-write of 4 DCBs, data of 512 DCBs and a post-write of 4 DCBs.

The pre-write represents a start of data, and is formed of a predetermined pattern, e.g., of “0011”. The post-write represents an end of data, and is formed of a predetermined pattern, e.g., of “1100”.

For example, the user data region in segment S1 includes a header, which is formed of a fixed pattern for confirming a position of data for reproduction, compensating a position of a reproduction clock, performing adjustment of a laser power and others. The fixed pattern recorded as the header is a so-called DC-free pattern, in which a DC component is suppressed, and bears a plurality of domains of 2T at intervals of 2T as well as a predetermined number of domains of 8T at intervals of 8T.

The phase compensation is performed by such adjustment that the timing of sampling of an analog signal obtained by reproducing the domains of 2T may match with the phase of the clock used for recording and reproducing the data. Also, the laser power is adjusted by reproducing domains of 2T and 8T such that a ratio of 50% or more may be achieved by the intensity of the reproduction signal of the domains of 8T with respect to the intensity of the reproduction signal of the domains of 2T. Further, the position of data during reproduction is confirmed by reproducing the domains of 8T and determining whether the position of the digital signal prepared from the reproduction signal may match with an expected position of the digital signal of the domains of 8T or not. Further, each of the patterns of the pre-write, post-write and header is recorded continuously to the user data when recording the user data.

The phase adjustment of the clock using the signals of 2T recorded in the header will be described later in greater detail.

Each of segments S2-S38 is formed of fine clock mark region FCM of 12 DCBs, the pre-write of 4 DCBs, the data of 512 DCBs and the post-write of 4 DCBs.

Regions, which are pre-formatted, e.g., for fine clock marks FCM and address, are referred to as “pre-formatted regions”.

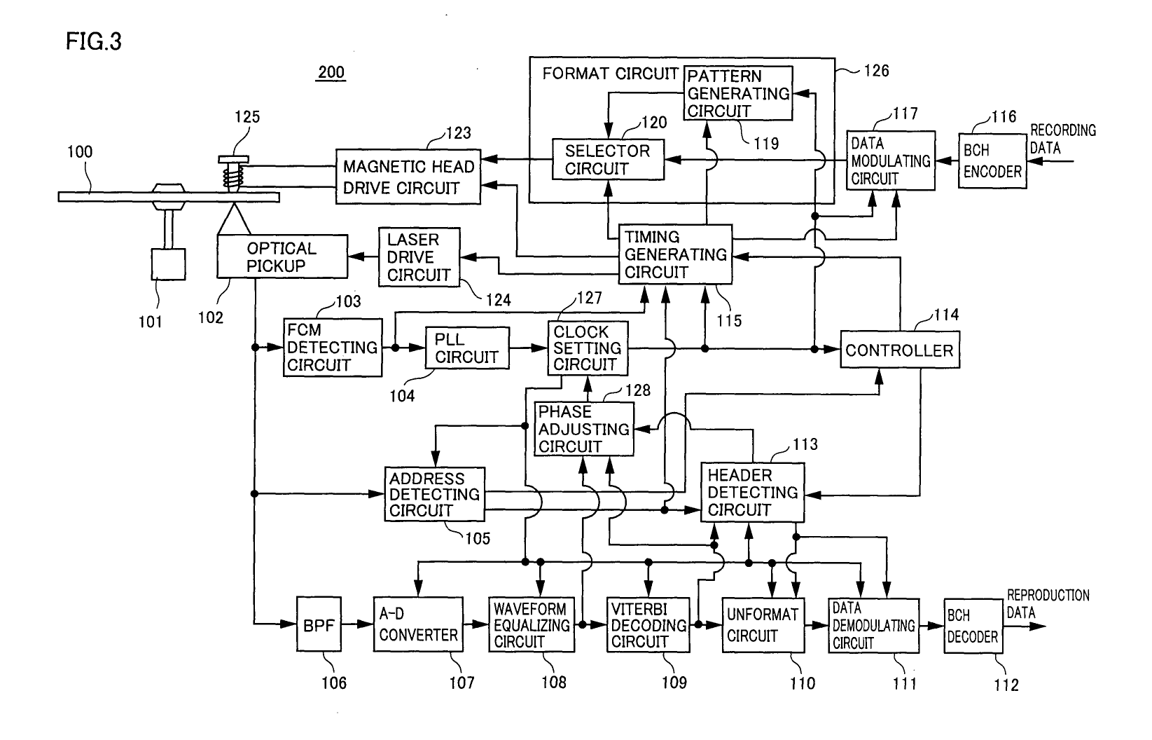

Referring to FIG. 3, description will now be given on an optical disk device according to the invention. An optical disk device 200 includes a spindle motor 101, an optical pickup 102, a fine clock mark detecting circuit (FCM detecting circuit) 103, a PLL circuit 104, an address detecting circuit 105, a BPF 106, an A-D converter 107, a waveform equalizing circuit 108, a Viterbi decoding circuit 109, an unformat circuit 110, a data demodulating circuit 111, a BCH decoder 112, a header detecting circuit 113, a controller 114, a timing generating circuit 115, a BCH encoder 116, a data modulating circuit 117, a format circuit 126, a magnetic head drive circuit 123, a laser drive circuit 124, a magnetic head 125, a clock setting circuit 127 and a phase adjusting circuit 128. Format circuit 126 includes a pattern generating circuit 119 and a selector circuit 120.

Spindle motor 101 drives a magneto-optical recording medium 100 at a predetermined rotation speed. Optical pickup 102 emits a laser beam to magneto-optical recording medium 100, and detects a reflected beam. FCM detecting circuit 103 detects a fine clock mark detection signal FCMT indicating a position of a fine clock mark 3 on magneto-optical recording medium 100, and outputs fine clock mark detection signal FCMT thus detected to PLL circuit 104 and timing generating circuit 115.

PLL circuit 104 produces a clock CK based on fine clock mark detection signal FCMT supplied from FCM detecting circuit 103, and sends clock CK thus produced to clock setting circuit 127.

Address detecting circuit 105 receives an address signal ADA, which is detected by optical pickup 102 from segment S0 on magneto-optical recording medium 100 in the radial push-pull method, detects address information AD in synchronization with clock CK supplied from clock setting circuit 127, and produces an address detection signal ADF, which indicates the fact that address information AD is detected, at the end position in the address information. Detected address information AD is sent to controller 114, and produced address detection signal ADF is sent to header detecting circuit 113 and timing generating circuit 115.

BPF 106 removes a high range and a low range of a signal RF reproduced from magneto-optical recording medium 100. A-D converter 107 converts reproduction signal RF from an analog form to a digital form in synchronization with clock CK sent from clock setting circuit 127.

Waveform equalizing circuit 108 performs PR (1, 1) waveform equalization on reproduction signal RF, which is converted into the digital form in synchronization with clock CK sent from clock setting circuit 127. More specifically, the equalization is performed such that waveform interference may occur at a rate of 1 to 1 between data before the detection signal and data after the same. Waveform equalizing circuit 108 provides the signal subjected to the waveform equalization to Viterbi decoding circuit 109 and phase adjusting circuit 128 Viterbi decoding circuit 109 converts reproduction signal RF from a multi-valued form to a binary form in synchronization with clock CK sent from clock setting circuit 127, and supplies reproduction signal RF thus converted to unformat circuit 110 and header detecting circuit 113.

Viterbi decoding-circuit 109 outputs a timing signal TN to phase adjusting circuit 128 in accordance with timing of change of the decoded data from “1” to “0”.

Unformat circuit 110 removes the pre-write, post-write and header recorded in the user data region on magneto-optical recording medium 100 in synchronization with a timing signal sent from header detecting circuit 113.

Data demodulating circuit 111 receives reproduction signal RF, which is unformatted, in synchronization with clock CK sent from clock setting circuit 127, and demodulates it for demodulating the digital modulation performed at the time of recording.

BCH decoder 112 corrects errors in the reproduction signal thus demodulated, and outputs it as reproduced data. Header detecting circuit 113 detects the position of the header included in the reproduction signal based on address information AD sent from controller 114 and address detection signal ADF sent from address detecting circuit 105, and produces the timing signals of pre-write and header from the reproduction signal in synchronization with clock CK sent from clock setting circuit 127. A timing signal TW of header thus produced is supplied to unformat circuit 110, data demodulating circuit 111 and phase adjusting circuit 128.

Controller 114 receives address information AD detected by address detecting circuit 105, and controls a servo-mechanism (not shown) based on address information AD to move optical pickup 102 to an intended position for access. Controller 114 outputs address information AD to header detecting circuit 113 in synchronization with clock CK sent from clock setting circuit 127, and controls timing generating circuit 115.

Under the control of controller 114, timing generating circuit 115 produces a timing signal SS, which is based on fine clock mark detection signal FCMT sent from FCM detecting circuit 103 and address detection signal ADF sent from address detecting circuit 105, in synchronization with clock CK sent from clock setting circuit 127, and applies timing signal SS thus produced to pattern generating circuit 119 and selector circuit 120 of format circuit 126 as well as magnetic head drive circuit 123 and laser drive circuit 124.

BCH encoder 116 adds an error correction code to the recording data. Data modulating circuit 117 modulates the recording data into a predetermined form. Format circuit 126 adds the pre-write, header and post-write to the recording data sent from data modulating circuit 117 in accordance with timing signal SS sent from timing generating circuit 115 so that the recording data may match with the user data region. Format circuit 126 selectively applies the formatted recording data and the pattern data to be recorded in the preformat region to magnetic head drive circuit 123 based on timing signal SS sent from timing generating circuit 115.

Pattern generating circuit 119 produces the pattern data to be recorded in the preformat region and the pattern data serving as the pre-write, header and post-write in synchronization with clock (CK) sent from clock setting circuit 127, and applies the produced data patterns to selector circuit 120.

Selector circuit 120 selects the recording data sent from data modulating circuit 117 and the pattern data sent from pattern generating circuit 119 based on timing signal SS sent from timing generating circuit 115, and applies the selected data to magnetic head drive circuit 123.

Magnetic head drive circuit 123 drives magnetic head 125 in synchronization with each timing of timing signal SS sent from timing generating circuit 115 and based on the output of format circuit 126.

Laser drive circuit 124 drives semiconductor laser (not shown) in optical pickup 102 based on timing signal SS sent from timing generating circuit 115.

Magnetic head 125 is driven by magnetic head drive circuit 123, and applies a magnetic field, which is magnetically modulated in accordance with the recording data or data pattern, to magneto-optical recording medium 100.

Clock setting circuit 127 is a circuit for setting the phase of the clock used for processing the reproduction signal when reproducing the signal from magneto-optical recording medium 100, and sets the optimum phase in clock CK sent from PLL circuit 104 based on the phase of the clock provided from phase adjusting circuit 128 in the manner, which will be described later. Clock setting circuit 127 outputs the clock having the optimum phase thus set to address detecting circuit 105, A-D converter 107, waveform equalizing circuit 108, Viterbi decoding circuit 109, unformat circuit 110, data demodulating circuit 111, controller 114, timing generating circuit 115, data modulating circuit 117 and pattern generating circuit 119 of format circuit 126. When recording the signal, clock setting circuit 127 outputs clock CK sent from PLL circuit 104 to address detecting circuit 105, controller 114, timing generating circuit 115, data modulating circuit 117 and pattern generating circuit 119 of format circuit 126 without changing the phase of clock CK.

Phase adjusting circuit 128 produces the clock having the phase suitable to the sampling of the reproduction signal in the manner, which will be described later.

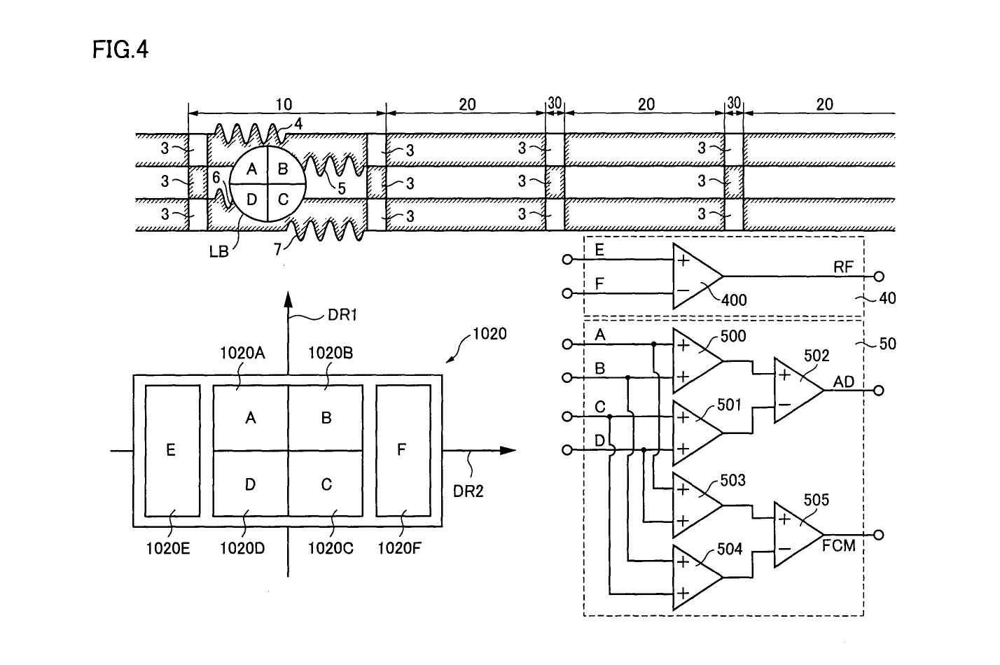

Referring to FIG. 4, description will now be given on detection of address information AD, a fine clock mark signal FCM and a magneto-optical signal RF on magneto-optical recording medium 100. Regions 10 and 30 are preformat regions, which are preformatted at the time of manufacturing of magneto-optical recording medium 100. Region 10 is provided with wobbles 4-7 and fine clock marks 3. Region 30 is provided with fine clock marks 3. A region 20 forms a user data region for recording the user data.

Optical pickup 102, which emits the laser beam to magneto-optical recording medium 10 and detects the reflected beam, includes a photo detector 1020 having six detection regions 1020A, 1020B, 1020C, 1020D, 1020E and 1020F. Regions A1020A and B1020B are arranged in a tangential direction DR2. Likewise, regions C1020C and D1020D as well as regions E1020E and F1020F are arranged in tangential direction DR2 relatively to each other. Regions A1020A and D1020D are arranged in a radial direction DR1 of magneto-optical recording medium 100, and regions B1020B and C1020C are likewise arranged in radial direction DR1.

Regions A1020A, B1020B, C1020C and D1020D detect laser beams LB, which are emitted to magneto-optical recording medium 100 and are reflected by regions A, B, C and D, respectively. Regions E1020E and F1020F detect the laser beams LB, which are reflected by whole the regions A, B, C and D, and are diffracted in different two directions of a plane of polarization by a Wollaston prism (not shown) of optical pickup 102.

Reproduction signal RF of the magneto-optical signal recorded in region 20, which is a user data region, is detected by arithmetically determining a difference between a laser beam intensity [E] detected by region E1020E of photo detector 1020 and a laser beam intensity [F] detected by region F1020F. Thus, a differential meter 400 of a circuit 40 arithmetically determines the difference between laser beam intensity [E] detected by region E1020E of photo detector 1020 and laser beam intensity [F] detected by region F1020F, and outputs reproduction signal RF equal to ([E]-[F]).

The reproduction signal of address information AD recorded by wobbles 4-7 in region 10, which forms the preformat region, is detected in a radial push-pull method, and is detected as a difference obtained by extracting a sum of laser beam intensities [C] and [D] detected by regions C1020C and D1020D from a sum of laser beam intensities [A] and [B] detected by regions A1020A and B1020B. Address information AD is detected by adders 500 and 501 and a subtractor 502 in a circuit 50. Adder 500 obtains and outputs a sum [A+B] of laser beam intensities [A] and [B] detected by regions A1020A and B1020B. Adder 501 obtains and outputs a sum [C+D] of laser beam intensities [C] and [D] detected by regions C1020C and D1020D. Subtractor 502 subtracts the output [C+D] of adder 501 from the output [A+B] of adder 500 to output a reproduction signal AD (=[A+B]−[C+D]) of the address information.

Fine clock mark FCM of region 30 forming the preformat region is detected by a tangential push-pull method, and thus is detected as a difference obtained by subtracting a sum of laser beam intensities [B] and [C] detected by regions B1020B and C1020C from a sum of laser beam intensities [A] and [D] detected by regions A1020A and D1020D. More specifically, fine clock marks FCM are detected by adders 503 and 504 and a subtractor 505 in circuit 50. Adder 503 outputs a sum [A+D] of laser beam intensities [A] and [D] detected by regions A1020A and D1020D. Adder 504 outputs a sum [B+C] of laser beam intensities [B] and [C] detected by regions B1020B and C1020C. Subtractor 505 subtracts output [B+C] of adder 504 from output [A+D] of adder 503, and outputs reproduction signal FCM (=[A+D]−[B+C]) of the fine clock marks.

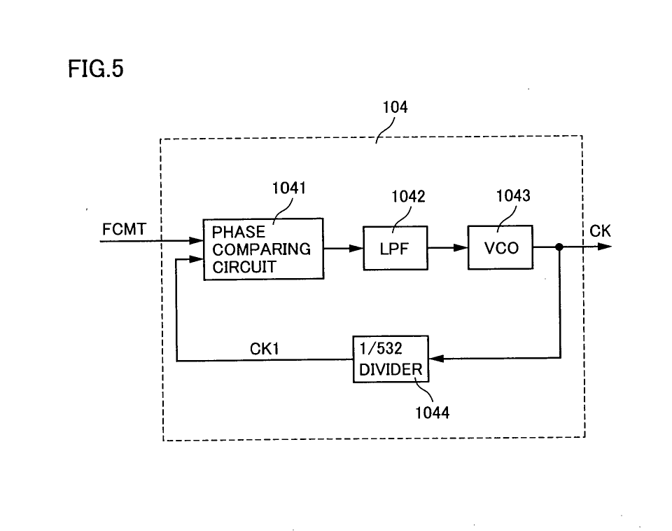

Referring to FIG. 5, description will now be given on a structure of PLL circuit 104 in optical disk device 200. PLL circuit 104 includes a phase comparing circuit 1041, an LPF 1042, a voltage control oscillator (VCO) 1043 and a 1/532 frequency divider 1044. 1/532 frequency divider 1044 divides clock CK generated by voltage control oscillator (VCO) 1043 to provide 1/532 of the input frequency. Phase comparing circuit 1041 compares the phase of clock CK1 divided by 1/532 frequency divider 1044 with the phase of fine clock mark detection signal FCMT, and generates the error voltage corresponding to the phase difference between these phases. Accordingly, PLL circuit 104 produces clock CK, which is synchronized with fine clock mark detection signal FCMT, and has a period of 1/532 of that of fine clock mark detection signal FCMT.

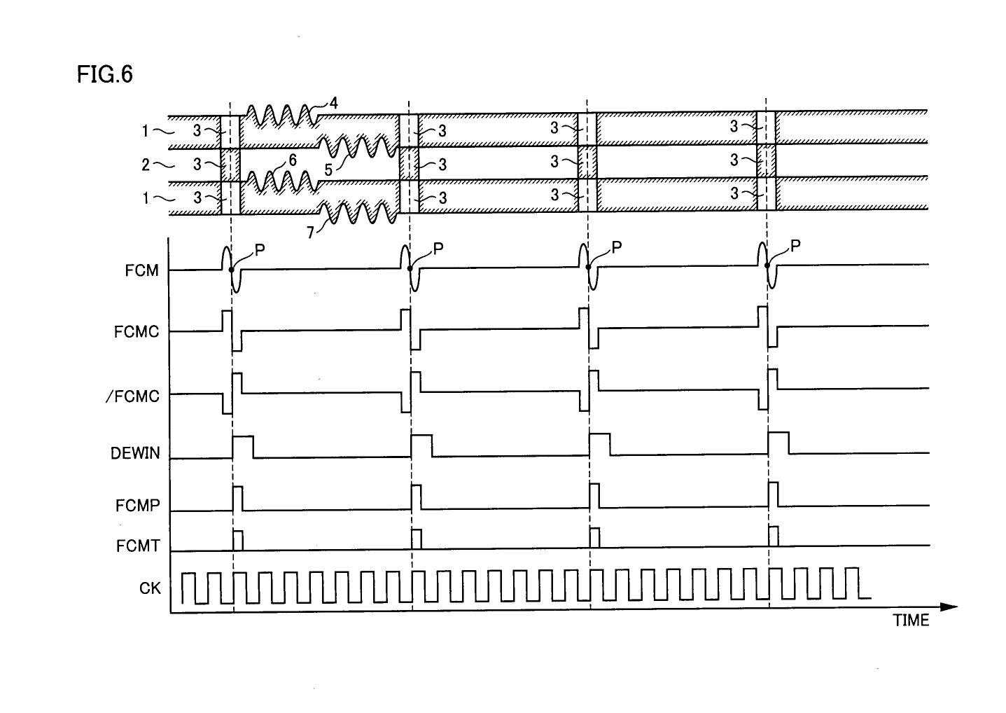

Referring to FIG. 6, description will now be given on detection of fine clock mark 3 and production of clock CK. Photo detector 1020 of optical pickup 102 detects fine clock mark signal FCM in the tangential push-pull method as already described with reference to FIG. 4, and outputs fine clock mark signal FCM thus detected to FCM detecting circuit 103. FCM detecting circuit 103 produces fine clock mark detection signal FCMT based on received fine clock mark signal FCM. Thus, FCM detecting circuit 103 makes a comparison of fine clock mark signal FCM based on a predetermined level to convert it into a signal FCMC. This signal FCMC is inverted into a signal/FCMC. Thereafter, a detection window signal DEWIN is produced. Detection window signal DEWIN has a rising edge synchronized with a point P of switching of the polarity of fine clock mark signal FCM, and also has an amplitude width of 6 DCBs. Logical AND is carried out between signal/FCMC and detection window signal DEWIN to produce a signal FCMP. Thereby, fine clock mark detection signal FCMT having an amplitude width of 1 DCB is produced in synchronization with the rising of signal FCMP.

According to the above description with reference to FIG. 6, fine clock mark signal FCM is detected by the laser beam moving on groove 1 of magneto-optical recording medium 100. In the case where the laser beam moves on land 2, the fine clock mark signal has the polarity opposite to the above, but the position of point P does not change. Even when the laser beam moves on land 2, therefore, signals FCMP and fine clock mark detection signal FCMT can be produced similarly.

FCM detecting circuit 103 outputs fine clock mark detection signal FCMT detected thereby to PLL circuit 104. PLL circuit 104 produces clock CK, which is synchronized with fine clock mark detection signal FCMT as already described with reference to FIG. 5, and is produced by dividing fine clock mark detection signal FCMT to provide 1/532 of the original frequency.

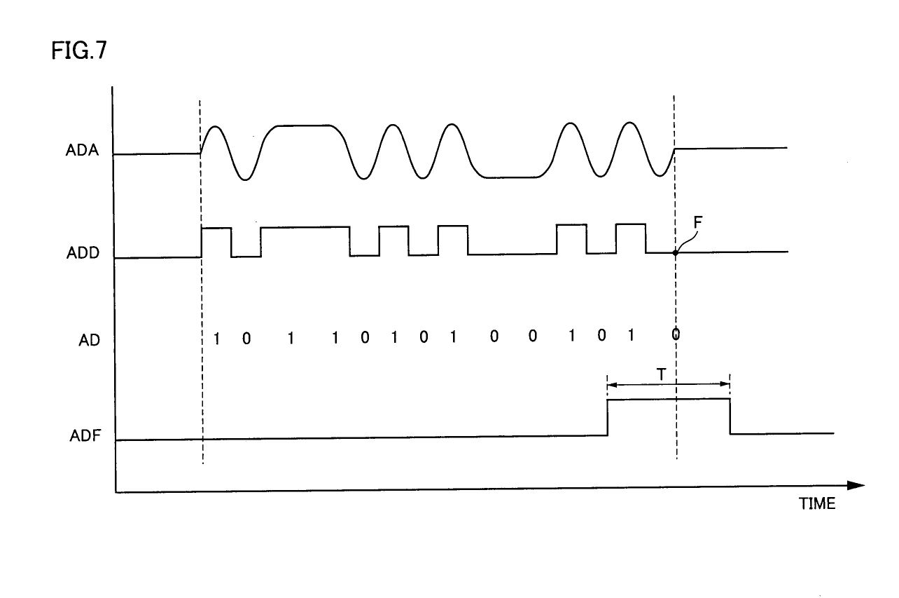

Referring to FIG. 7, description will now be given on the detection of address information in address detecting circuit 105 and the production of the address detection signal. Optical pickup 102 detects address signal ADA recorded as wobbles in the radial push-pull method as already described with reference to FIG. 4, and applies address signal ADA to address detecting circuit 105. Address detecting circuit 105 produces a binary signal ADD by changing address signal ADA into a binary form, and detects address information AD based on binary signal ADD. Also, address detecting circuit 105 produces address detection signal ADF, which indicates an end position F of the address signal, based on binary signal ADD and address information AD in synchronization with clock CK sent from clock setting circuit 127. Address detection signal ADF has a constant length T, which is determined to contain end position F of the address information. Thus, components of clock CK in and between positions corresponding to the start position of binary signal ADD and end position F of the address signal are counted. Assuming that a count value in end position F is equal to K, address detection signal ADF is produced such that a pulse component having a constant length T occurs between count values of (K−p) and (K+p), which are shifted forward and rearward from count value K by p counts, respectively.

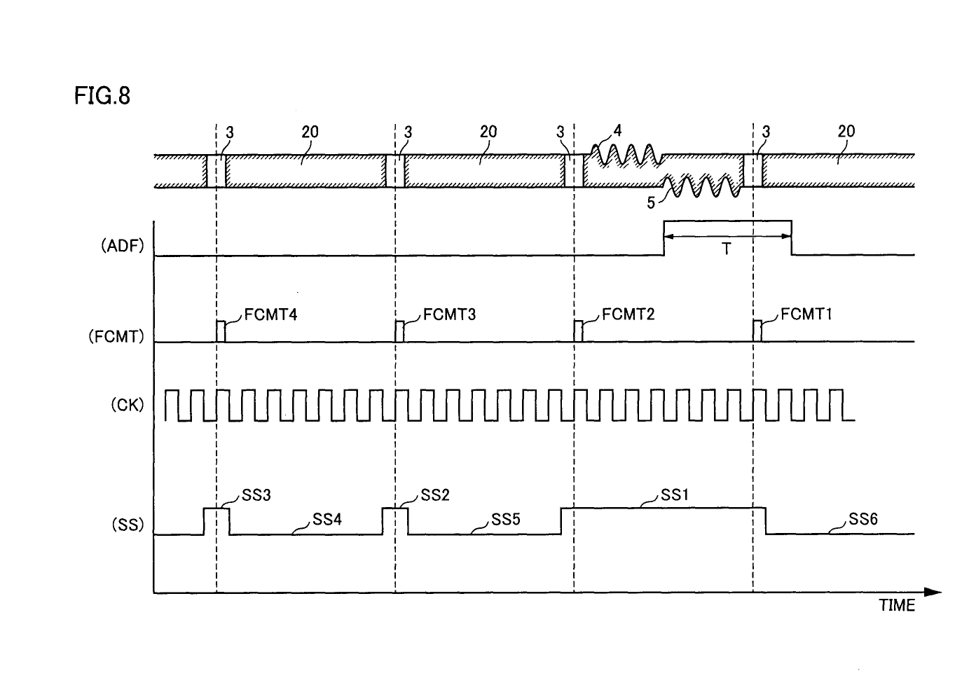

Referring to FIG. 8, description will now be given on production of timing signal SS in timing generating circuit 115. When timing generating circuit 115 receives address detection signal ADF sent from address detecting circuit 105, fine clock mark detection signal FCMT sent from FCM detecting circuit 103 and clock CK sent from clock setting circuit 127, timing generating circuit 115 determines whether address detection signal ADF is present in accordance with the timing of fine clock mark detection signal FCMT or not, and produces timing signal SS in synchronization with clock CK. Timing signal SS thus produced is formed of a component SS1 including a component FCMT1 of fine clock mark detection signal FCMT, in which address detection signal ADF is present, and components SS2 and SS3 containing only components FCMT3 and FCMT4 of fine clock mark detection signal FCMT. In this case, each of components FCMT1, FCMT2, FCMT3 and FCMT4 of fine clock mark detection signal FCMT is synchronized with a central position of fine clock mark 3, and fine clock mark 3 has a predetermined length of 12 DCBs. Therefore, timing generating circuit 115 produces component SS1 containing regions, where wobbles 4 and 5 are formed, and regions of fine clock marks 3 located on the opposite sides of the regions of wobbles 4 and 5. Timing generating circuit 115 also produces components SS2 and SS3 containing regions of fine clock marks 3, which correspond to components FCMT3 and FCMT4 of fine clock mark detection signal FCMT, respectively, and further produces components SS4, SS5 and SS6 each corresponding to region 20 for recording the user data.

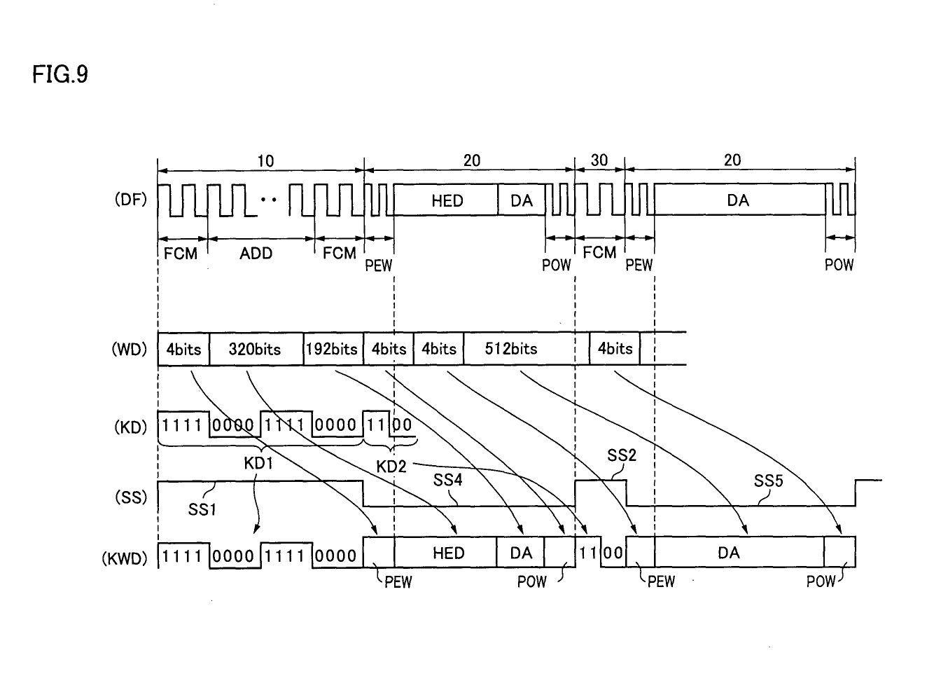

Referring to FIG. 9, description will now be given on the operation of selector circuit 120 in format circuit 126 of optical disk device 200 shown in FIG. 3. When selector circuit 120 receives timing signal SS from timing generating circuit 115, selector circuit 120 selects recording data (WD) sent from data modulating circuit 117 or pattern data (KD) sent from pattern generating circuit 119 based on timing signal SS. Selector circuit 120 selects pattern data (KD) sent from pattern generating circuit 119 when timing signal (SS) is at H (logical high) level, and selects recording data (WD) sent from data modulating circuit 117 when timing signal (SS) is at L (logical low) level.

When data structure (DF) on magneto-optical recording medium 100 has a structure of FCM/ADD/FCM/PEW/HED/DA/POW/FCM/PEW/DA/POW, data modulating circuit 117 outputs recording data (WD). When pattern generating circuit 119 outputs pattern data (KD), selector circuit 120 selects pattern data “1111000011110000” sent from pattern generating circuit 119 based on component SS1 of timing signal (SS), and outputs it to magnetic head drive circuit 123. Then, selector circuit 120 selects pre-write of 4 bits, header of 320 bits, data of 192 bits and post-write of 4 bits from recording data sent from data modulating circuit 117 based on component SS4, and outputs them to magnetic head drive circuit 123. Then, selector circuit 120 selects data pattern “1100” sent from pattern generating circuit 119 based on component SS2, and outputs it to magnetic head drive circuit 123. Then, selector circuit 120 selects pre-write of 4 bits, data of 512 bits and post-write of 4 bits from recording data (WD) sent from data modulating circuit 117 based on component SS5, and outputs them to magnetic head drive circuit 123. Thereby, recording data rows (KWD) are output to magnetic head drive circuit 123.

When recording data rows (KWD) are output to magnetic head drive circuit 123, a magneto-optical signal of “1111000011110000” is recorded in region 10 on magneto-optical recording medium 100 provided with FCM/ADD/FCM as can be seen from FIG. 9, and magneto-optical signal “1100” is recorded in region 30 provided with FCM. As described above, magneto-optical signals are recorded in the whole regions of data structure (DF) on magneto-optical recording medium 100. This is for the purpose of suppressing DC components in the reproduction signal when data is reproduced from region 20, i.e., user data region.

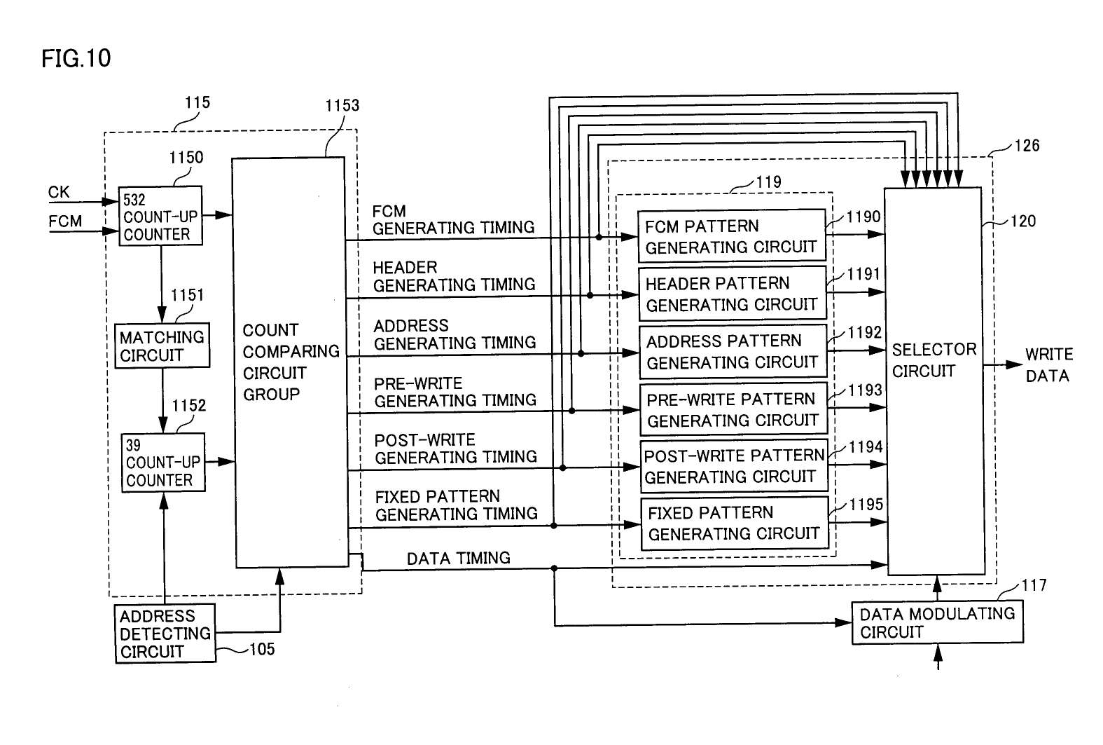

Referring to FIG. 10, description will now be given on pattern generating circuit 119 and selector 120 forming format circuit 126 as well as timing generating circuit 115 in optical disk device 200 shown in FIG. 3.

Timing generating circuit 115 includes a 532 count-up counter 1150, a matching circuit 1151, a 39 count-up counter 1152 and a count comparing circuit group 1153. When 532 count-up counter 1150 receives fine clock mark detection signal FCMT from FCM detecting circuit 103, 532 count-up counter 1150 is reset, and counts clock CK supplied from clock setting circuit 127 for applying the count value to matching circuit 1151 and count comparing circuit group 1153. Matching circuit 1151 determines whether the maximum value of the count value supplied from 532 count-up counter 1150 matches with 531 or not, and outputs a match signal MTC to 39 count-up counter 1152 when it determines matching. Address detection signal ADF supplied from address detecting circuit 105 resets 39 count-up counter 1152 so that 39 count-up counter 1152 counts match signal MTC, and outputs the count value to count comparing circuit group 1153.

Count comparing circuit group 1153 specifies segments S0-S38 on magneto-optical recording medium 100 based on the count value supplied from 39 count-up counter 1152, and specifies the positions of the fine clock mark, address, pre-write, post-write, header and data in each of segments S0-S38 based on the count value supplied from 532 count-up counter 1150. Count comparing circuit group 1153 outputs fine clock mark timing signals TSFCM1-TSFCM3 to an FCM pattern generating circuit 1190 and selector circuit 120 of pattern generating circuit 119 based on the specified position of the fine clock mark. Further, count comparing circuit group 1153 outputs header timing signal TSHED to a header pattern generating circuit 1191 and selector circuit 120 of pattern generating circuit 119 based on the specified position of the header. Further, count comparing circuit group 1153 outputs address timing signal TSAD to an address pattern generating circuit 1192 and selector circuit 120 of pattern generating circuit 119 based on the specified position of the address. Further, count comparing circuit group 1153 outputs pre-write timing signals TSPRW1 and TSPRW2 to a pre-write pattern generating circuit 1193 and selector circuit 120 of pattern generating circuit 119 based on the specified position of the pre-write. Further, count comparing circuit group 1153 outputs post-write timing signals TSPOW1 and TSPOW2 to a post-write pattern generating circuit 1194 and selector circuit 120 of pattern generating circuit 119 based on the specified position of the post-write. Further, count comparing circuit group 1153 outputs data timing signals TSDA1 and TSDA2 to format circuit 118 and selector circuit 120 based on the specified position of the data. When count comparing circuit group 1153 receives a defective frame detection signal from address detecting circuit 105, it outputs a fixed timing signal TSHLD to a fixed pattern generating circuit 1195 and selector circuit 120 of pattern generating circuit 119.

Pattern generating circuit 119 is formed of FCM pattern generating circuit 1190, header pattern generating circuit 1191, address pattern generating circuit 1192, pre-write pattern generating circuit 1193, post-write pattern generating circuit 1194 and fixed pattern generating circuit 1195. FCM pattern generating circuit 1190 produces pattern data, which is to be recorded in a region provided with the fine clock marks, in synchronization with fine clock mark timing signals TSFCM1-TSFCM3, and outputs it to selector circuit 120. Header pattern generating circuit 1191 produces pattern data to be recorded in the header region in synchronization with header timing signal TSHED, and outputs it to selector circuit 120.

Address pattern generating circuit 1192 produces pattern data to be recorded in the address region in synchronization with address timing signal TSAD, and outputs it to selector circuit 120. Pre-write pattern generating circuit 1193 produces pattern data to be recorded in the pre-write region in synchronization with pre-write timing signals TSPRW1 and TSPRW2, and outputs it to selector circuit 120.

Post-write pattern generating circuit 1194 produces pattern data to be recorded in the post-write region in synchronization with post-write timing signals TSPOW1 and TSPOW2, and outputs it to selector circuit 120. Fixed pattern generating circuit 1195 produces pattern data to be recorded in a scratched or damaged frame in synchronization with fixed timing signal TSHLD, and outputs it to selector circuit 120.

Selector circuit 120 outputs pattern data, which is supplied from FCM pattern generating circuit 1190 and is to be recorded in the fine clock mark region, to magnetic head drive circuit 123 in synchronization with fine clock mark timing signals TSFCM1-TSFCM3 supplied from count comparing circuit group 1153. Also, selector circuit 120 outputs pattern data, which is supplied from FCM pattern generating circuit 1190 and is to be recorded in the header region, to magnetic head drive circuit 123 in synchronization with header timing signal TSHED applied from count comparing circuit group 1153. Further, selector circuit 120 outputs pattern data, which is supplied from address pattern generating circuit 1192 and is to be recorded in the address region, to magnetic head drive circuit 123 in synchronization with the address timing signal TSAD supplied from count comparing circuit group 1153. Further, selector circuit 120 outputs pattern data, which is supplied from pre-write pattern generating circuit 1193 and is to be recorded in the pre-write region, to magnetic head drive circuit 123 in synchronization with pre-write timing signals TSPRW1 and TSPRW2 supplied from count comparing circuit group 1153. Further, selector circuit 120 outputs pattern data, which is supplied from post-write pattern generating circuit 1194 and is to be recorded in the post-write region, to magnetic head drive circuit 123 in synchronization with post-write timing signals TSPOW1 and TSPOW2 supplied from count comparing circuit group 1153. Further, selector circuit 120 outputs pattern data, which is supplied from fixed pattern generating circuit 1195 and is to be recorded in whole the defective frames, to magnetic head drive circuit 123 in synchronization with fixed timing signal TSHLD supplied from count comparing circuit group 1153.

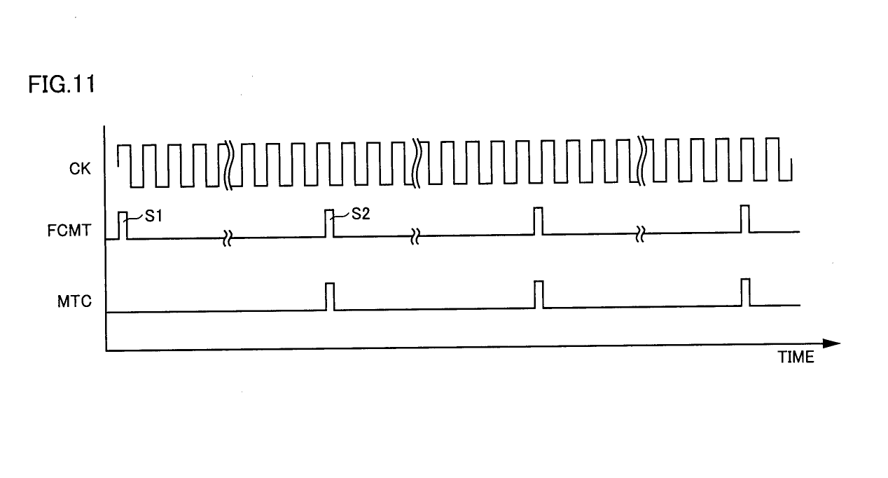

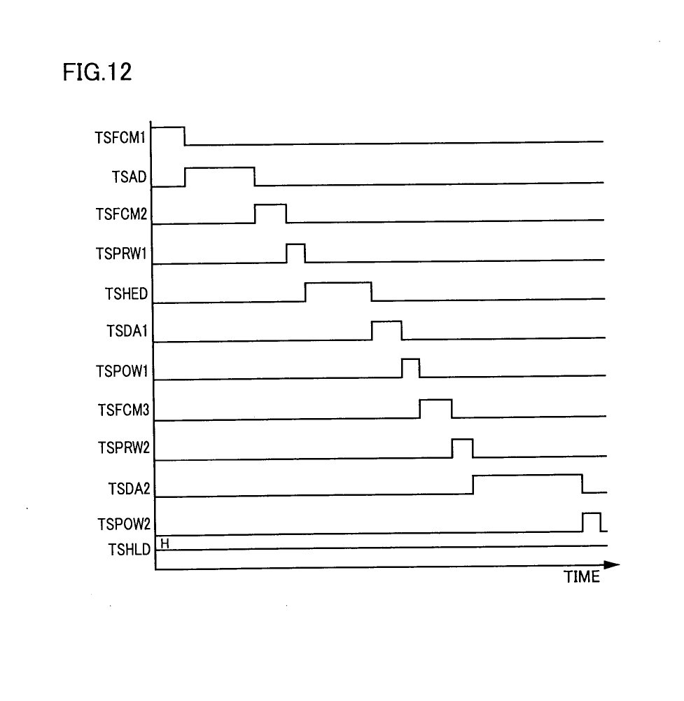

Referring to FIGS. 10-12, description will now be given on the operations of timing generating circuit 115, pattern generating circuit 119 and selector circuit 120. When FCM detecting circuit 103 supplies fine clock mark detection signal FCMT to 532 count-up counter 1150 in timing generating circuit 115, 532 count-up counter 1150 resets its count value, and counts clock CK supplied from clock setting circuit 127. Thus, 532 count-up counter 1150 is reset when it receives components S1, S2, . . . of fine clock mark detection signal FCMT illustrated in FIG. 11, and counts clock CK between neighboring components S1 and S2. Since 532 clock components are usually present between neighboring components S1 and S2 of fine clock mark detection signal FCMT, 532 count-up counter 1150 outputs a count value of 0-531 to matching circuit 1151 and count comparing circuit group 1153.

Thereby, matching circuit 1151 determines whether the maximum count value among the received count values is equal to 531 or not, and sends match signal MTC to 39 count-up counter 1152 when the maximum count value is equal to 531. Thereby, 39 count-up counter 1152 is reset when it receives address detection signal ADF from address detecting circuit 105, and counts match signal MTC to output the count value of 0-38 to count comparing circuit group 1153. Since address detection signal ADF is input in response to each frame, and thus every 39 segments, 39 count-up counter 1152 outputs the count value of 0-38 to count comparing circuit group 1153.

Count comparing circuit group 1153 recognizes segment S0, i.e., a region where address information AD is pre-formatted when count value supplied from 39 count-up counter 1152 is equal to 0. When the count value of 532 count-up counter 1150 is in a range of 0-11, or 12-531, count comparing circuit group 1153 recognizes the fine clock mark region in segment or the address region. Count comparing circuit group 1153 produces fine clock mark timing signal TSFCM1 and address timing signal TSAD, and supplies them to FCM pattern generating circuit 1190 and address pattern generating circuit 1192, respectively.

When the count value supplied from 39 count-up counter 1152 is equal to 1, count comparing circuit group 1153 recognizes segment S1. Then count comparing circuit group 1153 recognizes the fine clock mark region, pre-write region, header region, data region or post-write region when the count value of 532 count-up counter 1150 is in a range of 0-11, 12-15, 16-335, 336-525 or 526-529. Count comparing circuit group 1153 selectively outputs fine clock mark timing signal TSFCM3, pre-write timing signal TSPRW1, header timing signal TSHED, data timing signal TSDA1 and post-write timing signal TSPOW1 to output them to FCM pattern generating circuit 1190, pre-write pattern generating circuit 1193, header pattern generating circuit 1191, data modulating circuit 117 and post-write pattern generating circuit 1194, respectively.

When the count value supplied from 39 count-up counter 1152 is in a range from 2 to 38, count comparing circuit group 1153 recognizes segment S2-S38. Then, count comparing circuit group 1153 recognizes the fine clock mark region, pre-write region, data region or post-write region when the count value supplied from 532 count-up counter 1150 is in a range of 0-11, 12-15, 16-527 or 528-531. Count comparing circuit group 1153 selectively produces fine clock mark timing signal TSFCM3, pre-write timing signal TSPRW2, data timing signal TSDA2 and post-write timing signal TSPOW2 to output them to FCM pattern generating circuit 1190, pre-write pattern generating circuit 1193, data modulating circuit 117 and post-write pattern generating circuit 1194, respectively.

FCM pattern generating circuit 1190 produces pattern data “111100001111” of 12 DCBs to output it to selector circuit 120 in synchronization with each of fine clock mark timing signals TSFCM1-TSFCM3. Header pattern generating circuit 1191 produces pattern data of “11001100 . . . 110011111111000000001111111100000000 • • • 1111111100000000” to output it to selector circuit 120 in synchronization with header timing signal TSHED. The pattern data of 320 DCBs is pattern data for recording a predetermined number of signals of 2T at intervals of 2T as well as a predetermined number of signals of 8T at intervals of 8T, and is used for determining an optimum intensity of the laser beam, an optimum phase of the clock for sampling the reproduction signal and others.

Address pattern generating circuit 1192 produces pattern data “1111000011110000 . . . 11110000” of 520 DCBs in synchronization with address timing signal TSAD, and outputs it to selector circuit 120. Pre-write pattern generating circuit 1193 produces pattern data “0011” of 4 DCBs in synchronization with pre-write timing signals TSPRW1 and TSPRW2, and outputs it to selector circuit 120. Post-write pattern generating circuit 1194 produces pattern data “1100” of 4 DCBs in synchronization with post-write timing signals TSPOW1 and TSPOW2, and outputs it to selector circuit 120. Fixed pattern generating circuit 1195 produces pattern data “1111000011110000 . . . 1110000” of 20748 (=532×39) DCBs in synchronization with fixed pattern timing signal TSHLD, and output it to selector circuit 120.

Selector circuit 120 supplies pattern data “111100001111” of 12 DCBs to magnetic head drive circuit 123 in synchronization with fine clock mark timing signal TSFCM1, and supplies pattern data “1111000011110000 . . . 11110000” of 520 DCBs to magnetic head drive circuit 123 in synchronization with address timing signal TSAD.

Selector circuit 120 outputs pattern data “111100001111” of 12 DCBs to magnetic head drive circuit 123 in synchronization with fine clock mark timing signal TSFCM2, and outputs pattern data “0011” of 4 DCBs to magnetic head drive circuit 123 in synchronization with pre-write timing signal TSPRW.

Further, selector circuit 120 outputs pattern data “1100110011001100 . . . 111111110000000011111111” of 320 DCBs to magnetic head drive circuit 123 in synchronization with header timing signal TSHED, and outputs the recording data of 192 DCBs to magnetic head drive circuit 123 in synchronization with data timing signal TSDA1.

Further, selector circuit 120 outputs pattern data “1100” of 4 DCBs to magnetic head drive circuit 123 in synchronization with post-write timing signal TSPOW, and outputs pattern data “111100001111” of 12 DCBs to magnetic head drive circuit 123 in synchronization with fine clock mark timing signal TSFCM3.

Further, selector circuit 120 outputs pattern data “0011” of 4 DCBs to magnetic head drive circuit 123 in synchronization with pre-write timing signal TSPRW, outputs recording data of 512 DCBs to magnetic head drive circuit 123 in synchronization with data timing signal TSDA2 and outputs pattern data “1100” of 4DCBs to magnetic head drive circuit 123 in synchronization with post-write timing signal TSPOW. Further, selector circuit 120 outputs data “11110000 . . . 11110000” of 20748 DCBs to magnetic head drive circuit 123 in synchronization with fixed pattern timing signal TSHLD.

Thereby, recording data rows (KWD) shown in FIG. 9 are supplied to magnetic head drive circuit 123, and are recorded on magneto-optical recording medium 100.

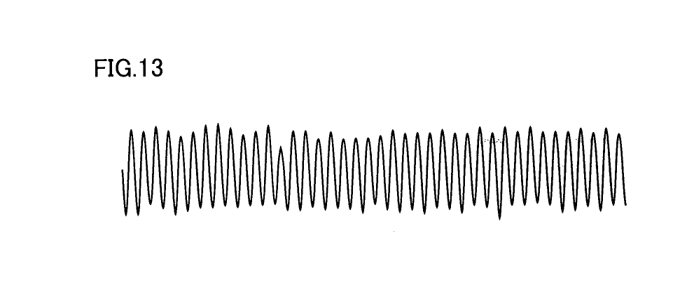

For reproducing the recording signal recorded on user data region 20, as described above, the phase of the clock is adjusted to suit to the sampling of the reproduction signal by reproducing the signals of 2T recorded in the header. In the header region, the signals of 2T are continuously recorded at intervals of 2T so that the signal reproduced from the header region has a sinusoidal form as shown in FIG. 13.

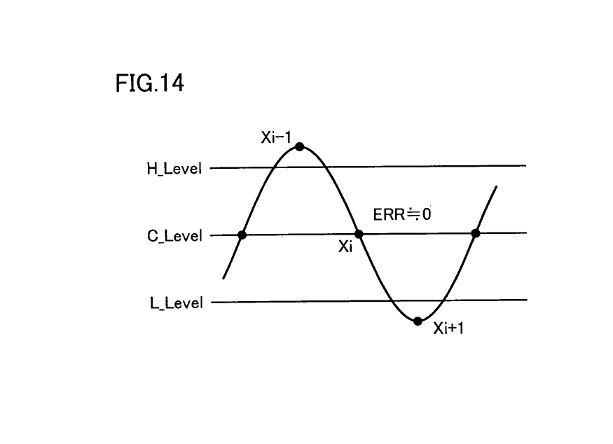

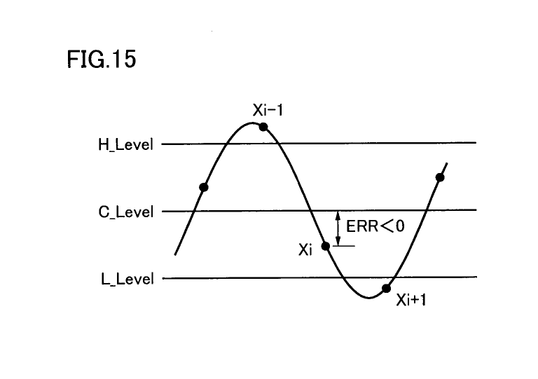

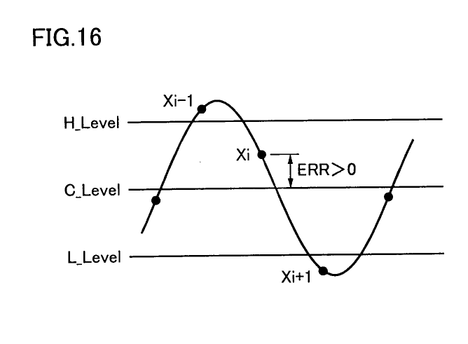

Referring to FIGS. 14 to 17, description will now be given on a principle of the clock phase adjustment. FIGS. 14 to 16 show waveforms of the reproduction signal of the signals of 2T reproduced from the header region. Circular marks represent timing of generation of the reproduction clock. FIG. 14 shows the case where the clock has the proper phase. FIG. 15 shows the case where the phase of clock leads the phase of the reproduction signal. FIG. 16 shows the case where the phase of the clock lags behind the phase of the reproduction signal. Xi−1, Xi and Xi+1 represent sampling values of the reproduction signal sampled in accordance with the timing of generation of the clock. H_Level, C_Level and L_Level represent expected values of the reproduction signal at the peak, center and bottom, respectively.

ERR represents a difference (ERR=Xi−C_Level) between sample value Xi near the center of the signal reproduced from the header region and expected value C_Level, and thus represents an amount or magnitude of the difference in phase between the reproduction signal and clock CK. When the clock has an appropriate phase (see FIG. 14), ERR is equal to zero, and the amount of phase difference between them is equal to zero. If the clock phase leads that of the reproduction signal (see FIG. 15), ERR is smaller than zero (ERR<0). If the clock phase lags behind the reproduction signal (see FIG. 16), ERR is larger than zero (ERR>0).

Accordingly, by determining whether ERR is positive or negative, it is possible to determine the manner for correcting the clock phase.

Therefore, a relationship of (ERR>0) or (ERR<0) is detected to calculate the required amount of phase correction of the clock, and the corrected clock is produced by correcting the clock phase based on the amount of phase correction thus calculated. The corrected clock is produced based on the plurality of 2T signals recorded in the header region, and the average phase of the clock thus corrected and produced is set as the phase of the reproduction clock.

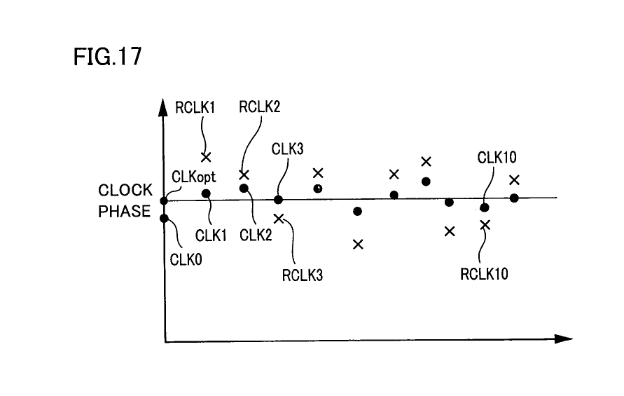

Referring to FIG. 17, a first reproduction signal RF1 reproduced from the header region is sampled with reference clock CLK0, and the sample value is compared with expected value C_Level to determine whether ERR is positive or negative, as described before. Depending on the polarity of ERR, corrected clock RCLK1 having the phase for appropriately sampling reproduction signal RF1 is reproduced. The moving average of the phase of corrected clock RCLK1 thus produced and the phase of reference clock CLK0 used for sampling reproduction signal RF1 is obtained, and clock CLK1 having the average phase thus obtained is handled as the clock suitable to sampling of reproduction signal RF1. Reference clock CLK0 is produced by PLL circuit 104 based on detection of fine clock mark 3 from magneto-optical recording medium 100.

A second reproduction signal RF2 of 2T signals reproduced from the header region is sampled with clock CLK1 suitable to the sampling of reproduction signal RF1, and the sample value thus obtained is compared with expected value C_Level to determine whether ERR is positive or negative. Depending on the polarity of ERR, corrected clock RCLK2 having the phase for appropriately sampling reproduction signal RF2 is produced. A shift average of the phase of corrected clock RCLK2 thus produced and the phase of clock CLK1 used for the sampling of reproduction signal RF2 is determined, and clock CLK2 having the average phase thus obtained is handled as the clock suitable to the sampling of reproduction signal RF2.

In the foregoing manner, clocks CLKn each having a phase suitable to sampling of reproduction signal RFn (n: natural number) of the 2T signal is successively obtained for the plurality of 2T signals recorded in the header region. The average of the n phases corresponding to respective clocks CLKn of n in number is obtained, and the clock having the average phase thus obtained is set as a reproduction clock CLKopt. Thereby, even if the plurality of 2T signals are recorded at mutually shifted positions in the header region, respectively, the sampling can be performed in accordance with the timing providing a large amplitude of the 2T signal at the shifted position.

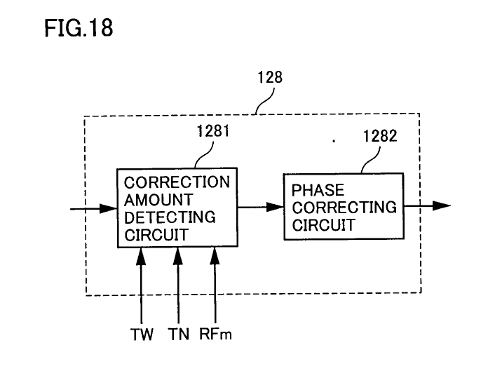

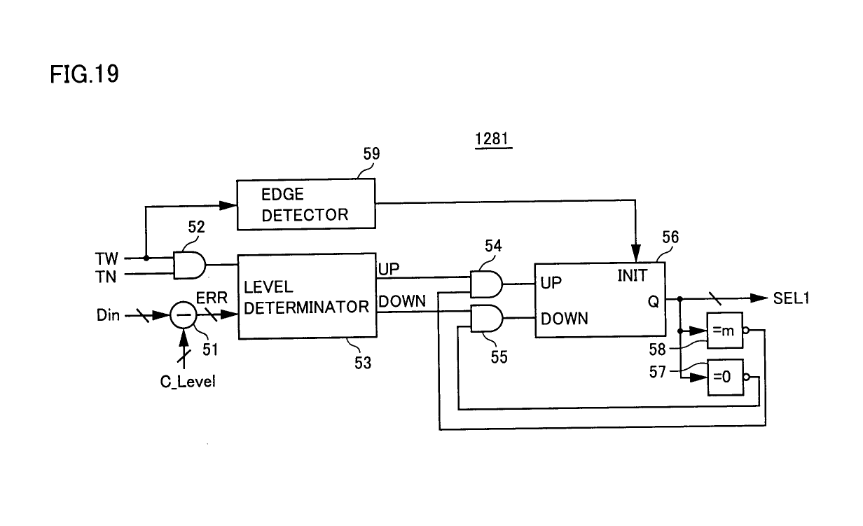

Referring to FIG. 18, phase adjusting circuit 128 of optical disk device 200 shown in FIG. 3 is formed of a correction amount detecting circuit 1281 and a phase correcting circuit 1282. Phase adjusting circuit 128 is configured to produce corrected clock RCLKn already described. Referring to FIG. 19, correction amount detecting circuit 1281 is formed of a subtractor 51, gates 52, 54 and 55, a level determinator 53, an up-down counter 56, comparators 57 and 58, and an edge detecting circuit 59. Subtractor 51 subtracts expected value C_Level from sample data Din received from waveform equalizing circuit 108 to provide phase shift amount ERR. Gate 52 receives timing signal TN, which is sent from Viterbi decoding circuit 109 and indicates a point of change of sample data Din from “1” to “0”, as well as timing signal TW, which is sent from header detecting circuit 113 and indicates detection of the header region, and outputs the timing signal indicating the position of Xi illustrated in FIGS. 14 to 16. Level determinator 53 determines from the above timing signal, i.e., the output of gate 52 whether phase shift amount ERR is within, below or above a predetermined range (i.e., a range not affecting the data production). Only when phase shift amount ERR falls outside the predetermined range, level determinator 53 issues an operation signal to gates 54 and 55. In the above case, and particularly when phase shift amount ERR is below the predetermined range, it issues an up instruction (UP) to up-down counter 56 via gate 54. When phase shift amount ERR is above the predetermined range, level determinator 53 issues a down instruction (DOWN) to up-down counter 56 via gate 55.

When gate 54 receives the up instruction from level determinator 53 and the signal sent from comparator 58 is at H-level (mismatch, <m), gate 54 issues the up instruction to up-down counter 56.

When gate 55 receives the down instruction from level determinator 53 and the signal sent from comparator 57 is at H-level (mismatch, <0), gate 55 issues the down instruction to up-down counter 56.

Comparators 57 and 58 output results of comparison with “m” and “0”, which are the upper and lower limits of the correction amount allowed in phase correcting circuit 1282, respectively. Comparators 57 and 58 function as limiters for preventing deviation of the value of up-down counter 56 from the range from 0 to m, and issue control signals when the value of up-down counter 56 reaches “m” or “0”. When up-down counter 56 receives the operation instruction signal sent from gate 52 as well as the up or down instruction sent from level determinator 53, up-down counter 56 counts up or down the count value by only one, and outputs the count value as correction amount SEL1 (i.e., count value).

Edge detecting circuit 59 produces the timing signal leading timing signal TW sent from header detecting circuit 113, and provides it to an INIT terminal of up-down counter 56. When up-down counter 56 receives on its INIT terminal the output of edge detecting circuit 59, an initial value equal to an integer value near m/2 is set. Thus, the initial value is set in up-down counter 56 in response to every detection of the header region.

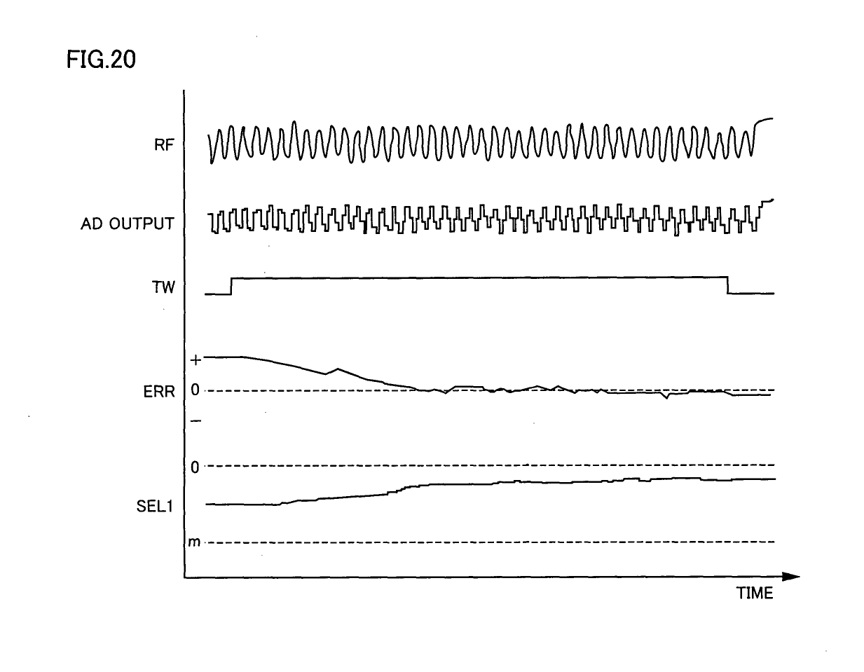

Referring to FIG. 20, the operation of correction amount detecting circuit 1281 will now be described. Reproduction signal RFn of the 2T signals detected by optical pickup 102 is converted by A-D converter 107 from the analog signal to the digital signal, and is supplied to the correction amount detecting circuit 1281 of phase adjusting circuit 128 via wave equalizing circuit 108. Further, header detecting circuit 113 sends detection signal TW of the header region to correction amount detecting circuit 1281 of phase adjusting circuit 128. Viterbi decoding circuit 109 outputs timing signal TN to correction amount detecting circuit 1281 of phase adjusting circuit 128. Thereby, the timing signal, which is sent from edge detecting circuit 59 and leads timing signal TW, is sent to the INIT terminal of up-down counter 56 so that correction amount SEL is set to the initial value of m/2. In accordance with timing signal TN indicating the position of Xi in FIGS. 14 to 17, level determinator 53 determines the level of phase shift amount ERR, and changes the count value of up-down counter 56. Up-down counter 56 outputs count value SEL1.

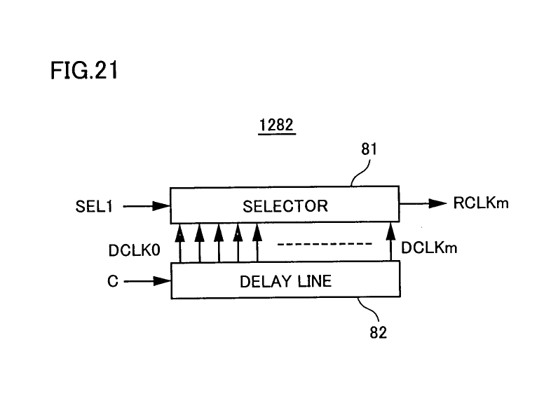

Referring to FIG. 21, phase correcting circuit 1282 is formed of a selector 81 and a delay line 82. In accordance with count value SEL1 sent from up-down counter 56, selector 81 selects one of delay clocks DCLK0-DCLKm, and outputs it as correction clock RCLKn. If count value n satisfies a relationship of (0≦n≦m), delay clock DCLKn is selected from delay clocks DCLK0-DCLKm. Delay line 82 receives clock CK from PLL circuit 104, and outputs (m+1) kinds of delay clocks DCLK0-DCLKm, which are spaced by an equal delay amount from each other.

When selector 81 receives count value SEL1 from up-down counter 56, it selects one delay clock DCLKn from delay clocks DCLK0-DCLKm sent from delay line 82 in accordance with the count value, and provides it as correction clock RCLKn to clock setting circuit 127.

As already described with reference to FIGS. 18-21, phase adjusting circuit 128 outputs correction clock RCLKn, which is prepared by correcting the phase of the clock defining the timing of sampling of the reproduction signal, in accordance with the sample value of the reproduction signal of 2T signals reproduced from the header region of magneto-optical recording medium 100.

Thereby, clock setting circuit 127 arithmetically obtains the moving average of correction clock RCLKn sent from phase adjusting circuit 128 and clock CLKn−1 suitable to the sampling of the last period signal, and thereby produces clock CLKn. Clock setting circuit 127 arithmetically determines the average of the n phases of n clocks CLKn, and sets the clock having the, average phase thus determined as the reproduction clock.

Thereby, even if the plurality of 2T signals are recorded at positions shifted from each other, the sampling can be performed in accordance with the timing providing the large amplitude of the reproduction signals of the plurality of 2T signals.

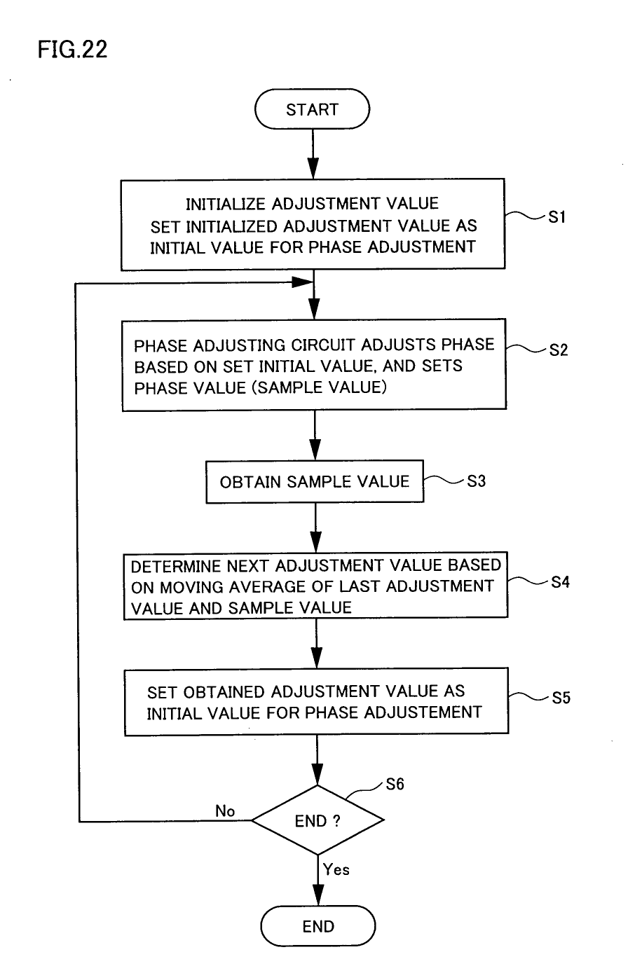

Referring to FIG. 22, description will now be given on the method of adjusting the phase of the clock according to the invention. When the adjusting operation starts, the adjustment value is initialized. Thus, the initialized adjustment value is set as the initial value for the phase adjustment (step S1). More specifically, the phase of clock CK provided from PLL circuit 104 is set as the initial value. Based on the initial value thus set, phase adjusting circuit 128 adjusts the phase of clock in the foregoing manner, and produces corrected clock RCLKn having the phase value thus adjusted (step S2). Thereafter, the adjusted phase value of corrected clock RCLKn is obtained as the sample value (step S3), and the moving average of the obtained sample value and the last adjustment value is arithmetically obtained to determine the next adjustment value (step S4). The adjustment value thus obtained is set as the initial value for the phase adjustment (step S5), and it is determined whether the adjustment is to be ended or not (step S6). If the adjustment operation is not to be ended, the processing returns to step S2, and steps S2 to S5 are repeated. If “YES” is selected in step S6, the phase adjustment operation ends.

Referring again to FIG. 3, description will now be given on an operation of recording data on magneto-optical recording medium 100 in optical disk device 200. When magneto-optical recording medium 100 is loaded into optical disk device 200, controller 114 controls a servo mechanism (not shown) to drive spindle motor 101 at a predetermined rotation speed, and controls laser drive circuit 124 via timing generating circuit 115 to emit a laser beam of a predetermined intensity from optical pickup 102.

Thereby, the servo mechanism (not shown) drives spindle motor 101 at a predetermined rotation speed, and spindle motor 101 drives magneto-optical recording medium 100 at a predetermined rotation speed. Optical pickup 102 collectively emits the laser beams of a predetermined intensity to magneto-optical recording medium 100 via an objective lens (not shown), and detects a beam reflected therefrom. Optical pickup 102 outputs a focus error signal and a tracking error signal to the servo mechanism (not shown) so that the servo mechanism turns on the focus servo and tracking servo of the objective lens of optical pickup 102 based on the focus error signal and the tracking error signal.

Thereafter, optical pickup 102 detects fine clock mark signal FCM from magneto-optical recording medium 100 in the radial push-pull method, and supplies fine clock mark signal FCM thus detected to FCM detecting circuit 103. FCM detecting circuit 103 detects fine clock mark detection signal FCMT from fine clock mark signal FCM in the method already described, and supplies fine clock mark detection signal FCMT thus detected to PLL circuit 104 and timing generating circuit 115. PLL circuit 104 produces clock CK based on fine clock mark detection signal FCMT, and supplies clock CK thus produced to clock setting circuit 127. Clock setting circuit 127 outputs received clock CK to address detecting circuit 105, controller 114, timing generating circuit 115, data modulating circuit 117 and format circuit 126, as it is.

Address detecting circuit 105 receives the address signal, which is detected by optical pickup 102 from segment S0 on magneto-optical recording medium 100 in the radial push-pull method, and detects address information AD in synchronization with clock CK supplied from clock setting circuit 127. Also, address detecting circuit 105 produces address detection signal ADF, which indicates the detection of address information AD, in the end position of address information AD. Address information AD thus detected is output to controller 114, and address detection signal ADF thus produced is output to header detecting circuit 113 and timing generating circuit 115.

BCH encoder 116 adds an error correction code to the recording data, and data modulating circuit 117 modules the recording data sent from BCH encoder 116 into a predetermined form in synchronization with clock CK sent from clock setting circuit 127. Data modulating circuit 117 outputs the modulated recording data to format circuit 126.

Timing generating circuit 115 produces a timing signal for producing a recording signal to be recorded in the data region of magneto-optical recording medium 100 based on the address information supplied from address detecting circuit 105. Timing generating circuit 115 supplies the timing signal thus produced to selector circuit 120, magnetic head drive circuit 123 and laser drive circuit 124.

Selector circuit 120 selects the recording signal supplied from data modulating circuit 117 in accordance with the timing signal, and supplies it to magnetic head drive circuit 123. Magnetic head drive circuit 123 drives magnetic head 125 so that the magnetic field modulated by the recording signal is produced in synchronization with the timing signal. Laser drive circuit 124 drives the semiconductor laser (not shown) in optical pickup 102 in synchronization with the timing signal, and optical pickup 102 collectively emits the laser beam to magneto-optical recording medium 100 via the objective lens (not shown). Magnetic head 125 applies the magnetic field modulated by the recording signal to magneto-optical recording medium 100. Thereby, the recording data is recorded on magneto-optical recording medium 100.

Description will now be given on the operation of reproducing the signal from magneto-optical recording medium 100 by optical disk device 200. Magneto-optical recording medium 100 is loaded into optical disk device 200, and the focus servo and tracking servo of the objective lens are performed. Also, clock CK is produced, and the address information is detected. These operations are the same as those for recording the signal. The detected address information is supplied to controller 114.

Header detecting circuit 113 detects the position of the header included in the reproduction signal based on the address information AD sent from controller 114 and address detection signal ADF sent from address detecting circuit 105, and produces the timing signals of the pre-write and header from the reproduction signal in synchronization with clock CK sent from clock setting circuit 127. The timing signal of the header thus produced is supplied to unformat circuit 110, data demodulating circuit 111 and phase adjusting circuit 128.

Optical pickup 102 supplies reproduction signal thus detected to BPF 106, which cuts off high and low ranges of the reproduction signal. A-D converter 107 converts the reproduction signal supplied from BPF 106 from the analog signal into the digital signal in synchronization with clock CK sent from clock setting circuit 127.

Waveform equalizing circuit 108 performs PR (1, 1) waveform equalization on the reproduction signal converted into the digital signal in synchronization with clock CK sent from clock setting circuit 127. Thus, the equalization is performed such that the waveform interference is performed at a rate of one to one between the data preceding the detected signal and the data following the same.

Thereafter, Viterbi decoding circuit 109 converts the reproduction signal already subjected to the waveform equalization from a multi-valued form into a binary form in synchronization with clock CK sent from clock setting circuit 127, and supplies the reproduction signal thus converted to unformat circuit 110 and header detecting circuit 113. Viterbi decoding circuit 109 outputs timing signal TN switching the reproduction signal from “1” to “0” to phase adjusting circuit 128.

Thereby, header detecting circuit 113 detects the position of the header included in the reproduction signal based on address information AD supplied from controller 114 and address detection signal ADF supplied from address detecting circuit 105, and produces the timing signals of the pre-write and header from the reproduction signal in synchronization with clock CK sent from clock setting circuit 127. The timing signal of the header thus produced is supplied to unformat circuit 110, data demodulating circuit 111 and phase adjusting circuit 127.

The phase adjustment of clock CK is performed using the 2T signals read from the header as described above.

Unformat circuit 110 removes the pre-write, post-write and header recorded in the user data region of magneto-optical recording medium 100 based on the timing signal supplied from header detecting circuit 113. Data demodulating circuit 111 receives the reproduction signal in the unformatted form in synchronization with clock CK sent from clock setting circuit 127, and performs the demodulation for decoding the digital modulation performed at the time of recording. BCH decoder 112 performs the error correction on the reproduction signal thus reproduced, and outputs it as the reproduction data. Thereby, reproduction of the signal from magneto-optical recording medium 100 is completed.

It has been described that the phase adjustment of the clock is performed using the reproduction signal of the 2T signals recorded in the header of the magneto-optical recording medium. According to the invention, however, signals other than the 2T signal may be used for adjusting the phase of the clock.

Although the magneto-optical recording medium has been described by way of example, the invention may be applied to optical disks other than magneto-optical recording medium provided that a position of a recorded signal shifts depending on a power of a laser beam emitted onto a phase change disk or the like.

According to the embodiment of the invention, since the phase of the clock used for sampling the reproduction signal is automatically adjusted using the 2T signals recorded in the header region of the magneto-optical recording medium, the sampling can be performed in accordance with the timing providing the large amplitude of the reproduction signal even if changes occur in position of the recorded signal.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL APPLICABILITY

Since the phase of the clock used for sampling the reproduction signal is automatically adjusted using the 2T signals recorded in the header region of the magneto-optical recording medium, the sampling can be performed in accordance with the timing providing the large amplitude of the reproduction signal even if changes occur in position of the recorded signal. Therefore, the invention can be applied to the optical disk device and the phase adjusting method for adjusting the phase of the reproduction clock to allow sampling in accordance with the timing providing the large amplitude of the reproduction signal.

1. An optical disk device (200) reproducing a signal from an optical disk (100) including a fine clock mark (3) providing a reference for producing a reference clock, comprising:
an optical pickup (102) emitting a laser beam onto said optical disk (100) and detecting a reflected beam;
a clock producing circuit (104) producing said reference clock based on a fine clock mark signal detected based on said fine clock mark by said optical pickup (102);
a sampling circuit (107) sampling a reproduction signal RFn (n: natural number) reproduced from said optical disk (100) by said optical pickup (102) in synchronization with said reference clock when n is equal to one, and sampling said reproduction signal RFn in synchronization with a clock CLKn−1 suitable to sampling of a reproduction signal RFn−1 immediately preceding said reproduction signal RFn when n is larger than one;
a phase adjusting circuit (128) determining a correction amount required for correction of a phase of said clock CLKn−1 by comparing a sample value of said reproduction signal RFn with a reference value, and producing a corrected clock RCLKn having a phase suitable to the sampling of said reproduction signal RFn based on said correction amount;
a clock setting circuit (127) producing a clock CLKn by arithmetically obtaining a moving average of said clock CLKn−1 and said correction clock RCLKn, arithmetically obtaining an average value of n phases corresponding to the respective clocks CLKn of n in number, and setting the clock having the arithmetically obtained average phase as a reproduction clock; and
a reproduction processing circuit (106-112) performing reproduction processing on the reproduction signal reproduced by said optical pickup (102) in synchronization with said reproduction clock.

2. The optical disk device according to claim 1, wherein
said reproduction signal RFn is a reproduction signal reproduced by said optical pickup (102) based on the recording signal recorded on the optical disk and having a uniform signal length.

3. The optical disk device according to claim 2, wherein
said reproduction signal RFn is the reproduction signal reproduced by the optical pickup (102) based on the recording signal recorded at a leading position of a user data region on said optical disk (100).

4. The optical disk device according to claim 1, wherein said optical disk (100) includes:
a land (2),
a groove (1) neighboring to said land (2), and
a magnetic layer covering surfaces of said land (2) and said groove (1);
said groove (1) and the land (2) include said fine clock marks at predetermined intervals in the tangential direction;
a data format of said optical disk (100) is formed of:
a plurality of frames, and
a plurality of segments (S0-S38) forming each of said plurality of frames;
a region between the neighboring two fine clock marks (3, 3) is assigned to each of said plurality of segments (S0-S38); and
said optical pickup (102) provides said reproduction signal RFn by detecting the recording signal recorded in one of said plurality of segments (S0-S38).

5. The optical disk device according to claim 1, wherein
said optical pickup (102) provides said reproduction signal RFn by detecting the recording signal recorded in one of said plurality of segments (S0-S38) forming each of said plurality of frames.

6. The optical disk device according to claim 4, wherein
a first recording signal having a first signal length and a second recording signal having a second signal length longer than said first signal length are recorded in said one segment, and
said optical pickup (102) reproduces said first recording signal to provide said reproduction signal RFn.

7. The optical disk device according to claim 5, wherein
a first recording signal having a first signal length and a second recording signal having a second signal length longer than said first signal length are recorded in said one segment, and
said optical pickup (102) reproduces said first recording signal to provide said reproduction signal RFn.

8. A phase adjusting method of adjusting a phase of a reproduction signal when reproducing a signal from an optical disk (100) including a fine clock mark (3) providing a reference for producing a reference clock, comprising:
a first step of reproducing a signal from said optical disk (100) by emitting a laser beam;
a second step of sampling a reproduction signal RFn (n: natural number) reproduced in said first step in synchronization with said reference clock when n is equal to one, and sampling said reproduction signal RFn in synchronization with a clock CLKn−1 suitable to sampling of a reproduction signal RFn−1 immediately preceding said reproduction signal RFn when n is larger than one;
a third step of determining a correction amount required for correction of a phase of said clock CLKn−1 by comparing a sample value of the reproduction signal RFn sampled in said second step with a reference value, and producing a corrected clock RCLKn having a phase suitable to the sampling of said reproduction signal RFn based on said correction amount; and
a fourth step of producing a clock CLKn by arithmetically obtaining a moving average of said clock CLKn−1 and said correction clock RCLKn, arithmetically obtaining an average value of n phases respectively corresponding to the clocks CLKn of n in number, and setting the clock having the arithmetically obtained average phase as a reproduction clock.

9. The phase adjusting method according to claim 8, wherein
said reproduction signal RFn is a reproduction signal based on the recording signal recorded on an optical disk (100) and having a uniform signal length.
